(19) United States
(12) Patent Application Publication
(10) Pub. No.: US 2011/0089804 A1
(43) Pub. Date: Apr. 21, 2011

(54) THERMAL MANAGEMENT OF LED-BASED ILLUMINATION DEVICES WITH SYNTHETIC JET EJECTORS

(75) Inventors: Raghavendran Mahalingam, Austin, TX (US); Samuel N. Heffington, Austin, TX (US); Stephen P. Darbin, Austin, TX (US); Daniel N. Grimm, Round Rock, TX (US)

(73) Assignee: Nuventix Inc.

(21) Appl. No.: 12/902,295

(22) Filed: Oct. 12, 2010

Related U.S. Application Data
(63) Continuation-in-part of application No. 12/503,181, filed on Jul. 15, 2009.
(60) Provisional application No. 61/134,984, filed on Jul. 15, 2008.

(51) Int. Cl. H01J 61/52; H01J 5/00; H01K 1/26; H01K 1/30

(52) U.S. Cl. 313/46; 313/317; 313/113; 313/110

(57) ABSTRACT

An illumination device (b1-01) is provided which comprises a housing (b1-03) equipped with an aperture (b1-37), first (b1-33) and second (b1-35) diaphragms disposed in said housing and in fluidic communication with said aperture, and an LED (b1-15) disposed between said first and second diaphragms.

### CROSS-REFERENCE TO RELATED APPLICATIONS

The present application is a continuation-in-part of U.S. Ser. No. 12/503,181, entitled “THERMAL MANAGEMENT OF LED-BASED ILLUMINATION DEVICES WITH SYNTHETIC JET EJECTORS” (Heffington et al.), filed on Jul. 15, 2009, and which is incorporated herein by reference in its entirety, and which claims priority to U.S. Ser. No. 61/134,984, entitled “THERMAL MANAGEMENT OF LED-BASED ILLUMINATION DEVICES WITH SYNTHETIC JET EJECTORS” (Heffington et al.), filed on Jul. 15, 2008, and which is incorporated herein by reference in its entirety.

### FIELD OF THE DISCLOSURE

The present disclosure relates generally to the thermal management of illumination devices, and more particularly to the thermal management of LED-based illumination devices through the use of synthetic jet ejectors.

### BACKGROUND OF THE DISCLOSURE

A variety of thermal management devices are known to the art, including conventional fan based systems, piezoelectric systems, and synthetic jet ejectors. The latter type of system has emerged as a highly efficient and versatile solution where thermal management is required at the local level. Frequently, synthetic jet ejectors are utilized in conjunction with a conventional fan based system. In such hybrid systems, the fan based system provides a global flow of fluid through the device being cooled, while the synthetic jet ejectors provide localized cooling for hot spots, and also augment the global flow of fluid within the device through the perturbation of boundary layers.

Various examples of synthetic jet ejectors are known to the art. Some examples include those disclosed in U.S. 20070141453 (Mahalingam et al.) entitled “Thermal Management of Batteries using Synthetic Jets”; U.S. 20070127210 (Mahalingam et al.), entitled “Thermal Management System for Distributed Heat Sources”; 20070119575 (Glezer et al.), entitled “Synthetic Jet Heat Pipe Thermal Management System”; 20070119573 (Mahalingam et al.), entitled “Synthetic Jet Ejector for the Thermal Management of PCI Cards”; 20070096118 (Mahalingam et al.), entitled “Synthetic Jet Cooling System for LED Module”; 20070081027 (Beltran et al.), entitled “Acoustic Resonator for Synthetic Jet Generation for Thermal Management”; and 20070023169 (Mahalingam et al.), entitled “Synthetic Jet Ejector for Augmentation of Pumped Liquid Loop Cooling and Enhancement of Pool and Flow Boiling”.

### BRIEF DESCRIPTION OF THE DRAWINGS

FIG. A1-1 is an illustration of an illumination device in accordance with the teachings herein.

FIG. A1-2 is an illustration of an illumination device in accordance with the teachings herein.

FIG. A1-3 is an illustration of an illumination device in accordance with the teachings herein.

FIG. A2-1 is an illustration of an illumination device in accordance with the teachings herein.

FIG. A3-1 is an illustration of an illumination device in accordance with the teachings herein.

FIG. A4-1 is an illustration of an illumination device in accordance with the teachings herein.

FIG. A5-1 is an illustration of an illumination device in accordance with the teachings herein.

FIG. A6-1 is an illustration of an illumination device in accordance with the teachings herein.

FIG. B1-1 is an illustration of an illumination device in accordance with the teachings herein.

FIG. C1-1 is an illustration of an illumination device in accordance with the teachings herein.

FIG. C2-1 is an illustration of an illumination device in accordance with the teachings herein.

FIG. C3-1 is an illustration of an illumination device in accordance with the teachings herein.

FIG. C4-1 is an illustration of an illumination device in accordance with the teachings herein.

FIG. C4-2 is an illustration of the synthetic jet ejector/heat sink combination utilized in the illumination device of FIG. C4-1.

FIG. D1-1 is an illustration of an illumination device in accordance with the teachings herein.

FIG. D1-2 is an illustration of an illumination device in accordance with the teachings herein.

FIG. D2-1 is an illustration of an illumination device in accordance with the teachings herein.

FIG. D2-2 is an illustration of a portion of the housing structure of the illumination device of FIG. D2-1.

FIG. D3-1 is an illustration of an illumination device in accordance with the teachings herein.

FIG. E1-1 is an illustration of an illumination device in accordance with the teachings herein.

FIG. E2-1 is an illustration of an illumination device in accordance with the teachings herein.

FIG. E3-1 is an illustration of an illumination device in accordance with the teachings herein.

FIG. E4-1 is an illustration of an illumination device in accordance with the teachings herein.

FIG. F1-1 is an illustration of an illumination device in accordance with the teachings herein.

FIG. G1-1 is an illustration of an illumination device in accordance with the teachings herein.

FIG. G2-1 is an illustration of an illumination device in accordance with the teachings herein.

FIG. H1-1 is an illustration of an illumination device in accordance with the teachings herein.

FIG. H2-1 is an illustration of an illumination device in accordance with the teachings herein.

FIG. H3-1 is an illustration of an illumination device in accordance with the teachings herein.

FIG. I1-1 is an illustration of an illumination device in accordance with the teachings herein.

FIG. I1-2 is an exploded view of the illumination device of FIG. I1-1.

FIG. I1-3 is an illustration of the illumination device of FIG. I1-1 depicting the manner in which the upper wall integrates with the heat sink to form flow paths.

FIG. I1-4 is a cross-sectional view taken along LINE I1-4-I1-4 of the illumination device of FIG. I1-1 depicting the flow paths between the synthetic jet actuators and the heat sink.

### DETAILED DESCRIPTION

The devices and methodologies disclosed herein may be further understood with reference to the particular, non-limiting embodiments of the illumination devices depicted in FIGS. A1-1 through I1-4 herein. In these figures, like elements have been given like numerical identifiers. A listing of the numerical identifiers is attached hereto as APENDIX A.

FIGS. A1-1 to A1-3 depict a first particular, non-limiting embodiment of an LED-based illumination device in accordance with the teachings herein. As seen therein, the illumination device a1-01 comprises a light-emitting portion a1-03 which emits light, and a connector module a1-05 which connects the illumination device a1-01 to the electrical outlet of a light fixture. In the particular embodiment depicted, the connector module a1-05 is a threaded connector module that rotatingly engages a complimentary shaped socket in an electrical outlet (not shown), though it will be appreciated that the illumination devices disclosed herein are not necessarily limited to use in conjunction with such an outlet.

The light emitting portion a1-01 in this embodiment houses a pedestal a1-25 (see FIG. A1-2) upon which is disposed a synthetic jet ejector a1-09. The synthetic jet ejector a1-09 comprises a housing a1-11 which contains a set of diaphragms a1-13, and upon an exterior surface of which are disposed a plurality of LEDs a1-15. The set of diaphragms a1-13 operate to generate a plurality of synthetic jets a1-17, which are emitted from a plurality of apertures a1-20 (see FIG. A1-3) provided in the synthetic jet actuator housing a1-11, and which transfer heat from the LEDs to the interior of the light emitting portion a1-03. The apertures a1-20 may be disposed in a variety of suitable patterns around one or more of the LEDs a1-15, one particular example of which is depicted in FIG. A1-3. The heat in the interior of the light emitting portion a1-03 may then be transferred to the external environment through thermal transfer across the surface of the light emitting portion a1-03 or by other suitable means.

FIG. A2-1 depicts another particular, non-limiting embodiment of an LED-based illumination device in accordance with the teachings herein is disclosed. As seen therein, the illumination device a2-01 comprises a light-emitting portion a2-03 which emits light, and a connector module a2-05 which connects the illumination device a2-01 to the electrical outlet of a light fixture. In the particular embodiment depicted, the connector module a2-05 is a threaded connector module that rotatingly engages a complimentary shaped socket in an electrical outlet (not shown), though it will be appreciated that the illumination devices disclosed herein are not necessarily limited to use in conjunction with such an outlet.

The light emitting portion a2-01 in this embodiment contains a synthetic jet actuator housing a2-11 which contains a set of diaphragms a2-13, and upon an exterior surface of which are disposed a plurality of LEDs a2-15. The set of diaphragms a2-13 operate to generate a plurality of synthetic jets a2-17, which are emitted from a plurality of apertures (not shown) provided in the synthetic jet actuator housing a2-11, and which transfer heat from the LEDs a2-15 to the interior of the light emitting portion a2-03. The apertures may be disposed in a variety of suitable patterns around one or more of the LEDs a2-15, one particular example of which is depicted in FIG. A2-1. The heat in the interior of the light emitting portion a2-03 may then be transferred to the external environment through thermal conduction, through the provision of apertures or vents in the light emitting portion a2-03, or by other suitable means.

The embodiment of FIG. A2-1 differs from the embodiment of FIGS. A1-1 to A1-3 in that the pedestal a1-25 of the embodiment of FIGS. A1-1 to A1-3 has essentially been replaced with the synthetic jet actuator housing a2-11. Such a construction allows for the use of larger diaphragms a2-13 which, in some applications and embodiments, may allow the synthetic jet actuator a2-07 to dissipate a larger amount of heat than a comparable device with smaller diaphragms a2-13.

FIG. A3-1 depicts another particular, non-limiting embodiment of an LED-based illumination device in accordance with the teachings herein. As seen therein, the illumination device a3-01 comprises a light-emitting portion a3-03 which emits light, and a connector module a3-05 which connects the illumination device a3-01 to the electrical outlet of a light fixture. In the particular embodiment depicted, the connector module a3-05 is a threaded connector module that rotatingly engages a complimentary shaped socket in an electrical outlet (not shown), though it will be appreciated that the illumination devices disclosed herein are not necessarily limited to use in conjunction with such an outlet.

The connector module a3-05 in this embodiment contains a synthetic jet actuator a3-07 which is equipped with a set of diaphragms a3-13. The synthetic jet actuator a3-07 is in fluidic communication with a pedestal a3-25 which is equipped on one end with a plenum a3-12. The plenum a3-12 is equipped with a plurality of apertures a3-20, and has a plurality of LEDs a3-15 disposed on an exterior surface thereof. The set of diaphragms a3-13 operate to generate a plurality of synthetic jets a3-17, which are emitted from a plurality of apertures a3-20 provided in the plenum a3-12, and which transfer heat from the LEDs a3-15 to the interior of the light emitting portion a3-03. The apertures a3-20 may be disposed in a variety of suitable patterns around one or more of the LEDs a3-15. The heat in the interior of the light emitting portion a3-03 may then be transferred to the external environment through thermal conduction, through the provision of apertures or vents in the light emitting portion a3-03, or by other suitable means.

The embodiment of FIG. A3-1 differs from the embodiment of FIGS. A1-1 to A1-3 in that the synthetic jet actuator a3-07 has been moved from the light emitting portion a3-03 of the device to the connector module a3-05. This arrangement is advantageous in some applications in that more of the interior space of the light emitting portion a3-03 is available for other purposes. It will be appreciated that this embodiment may offer greater flexibility in some applications with respect to the size and dimensions of the plenum a3-12, and the manner in which the LEDs a3-15 are disposed thereon.

FIG. A4-1 depicts another particular, non-limiting embodiment of an LED-based illumination device in accordance with the teachings herein. The illumination device a4-01 depicted therein comprises a light-emitting portion a4-03 which emits light, and a connector module a4-05 which connects the illumination device a4-01 to the electrical outlet of a light fixture.

This embodiment is similar to the embodiment of FIG. A1-3, except that the pedestal a1-25 of that embodiment has been replaced with a heat pipe a4-49. The heat pipe a4-49 is preferably in thermal communication with the connector module a4-05. A plurality of LEDs a4-15 are disposed on one end of the heat pipe a4-49. In some variations of this embodiment, the LEDs a4-15 may be mounted on a portion of the heat pipe a4-49 or on a thermally conductive substrate which is in thermal contact with the heat pipe a4-49. In some instances, this thermally conductive substrate may be the housing of a synthetic jet ejector or plenum thereof as in FIGS. A1-2 or A3-1, though variations of this embodiment are also contemplated which are devoid of a synthetic jet ejector.

FIG. A5-1 depicts another particular, non-limiting embodiment of an LED-based illumination device in accordance with the teachings herein. The illumination device a5-01 depicted therein comprises a light-emitting portion a5-03 which emits light, and a connector module a5-05 which connects the illumination device a5-01 to the electrical outlet of a light fixture.

The illumination device a5-01 in this embodiment is a hybrid of the embodiments depicted in FIGS. A1-2 and A2-1. In particular, this embodiment utilizes a vertical arrangement of the diaphragms a5-13 in the synthetic jet ejector a5-09, but also utilizes a pedestal a5-25. In some variations, the pedestal a5-25 may be replaced with, or may include, a heat pipe.

The illumination device a5-01 in this embodiment is also equipped with a vent a5-23 which allows the atmosphere inside of the light emitting portion a5-03 to be in fluidic communication with the external atmosphere. In some variations of this embodiment, the synthetic jet ejector a5-09 may be adapted to emit synthetic jets from apertures in the vent a5-23, either solely or in addition to emitting synthetic jets a5-17 from the actuator housing a5-11.

FIG. A6-1 depicts another particular, non-limiting embodiment of an LED-based illumination device in accordance with the teachings herein. The illumination device a6-01 depicted therein comprises a light-emitting portion a6-03 which emits light, and a connector module a6-05 which connects the illumination device a6-01 to the electrical outlet of a light fixture.

The illumination device a6-01 in this embodiment is similar in many respects to the illumination device a5-01 of FIG. A5-1, but is equipped on an external surface thereof with a series of heat fins a6-27. The synthetic jet ejector a6-09 in this embodiment is adapted to direct a synthetic jet a6-17 into each channel a6-37 defined by an opposing pair of heat fins a6-27. The illumination device a6-01 in this embodiment is also equipped with a vent a6-23 which brings the atmosphere inside of the light emitting portion a6-03 into fluidic communication with the external atmosphere. In some variations of this embodiment, the synthetic jet ejector a6-09 may be adapted to emit synthetic jets from apertures in the vent a6-23 in addition to the synthetic jets a6-17 which are emitted from the synthetic jet ejector a6-09.

FIG. B1-1 depicts another particular, non-limiting embodiment of an LED-based illumination device in accordance with the teachings herein. The illumination device b1-01 depicted therein comprises a light-emitting portion b1-03 which emits light, and a connector module b1-05 which connects the illumination device b1-01 to the electrical outlet of a light fixture.

The light emitting portion b1-03 in this embodiment contains an active diaphragm b1-33 and a passive diaphragm b1-35 which are in fluidic communication with each other. A heat sink b1-59 comprising at least one heat fin b1-27 is disposed between the active diaphragm b1-33 and the passive diaphragm b1-35 and has a plurality of LEDs b1-15 disposed thereon. Each heat fin b1-27 has at least one channel b1-37 defined therein which is in fluidic communication with the environment external to the light emitting portion.

In operation, the active diaphragm b1-33 vibrates to produce a plurality of synthetic jets b1-17 in the air passing through the channels b1-37 and into the external environment. Hence, as the heat fins b1-27 absorb heat from the LEDs b1-15 mounted on the heat sink b1-59, this operation ensures that the heat is efficiently transferred to the external environment through the turbulent flow created by the synthetic jets b1-17. During operation, the larger passive diaphragm b1-35 basically serves as a counterweight to the active diaphragm b1-33, which allows the synthetic jet actuator b1-09 to provide sufficient heat flux while operating outside of the audible range and producing fewer vibrations.

The passive diaphragm b1-35 preferably has the same mass as the active diaphragm b1-33, although the dimensions of the two diaphragms may be the same or different. The passive diaphragm b1-35 may also be of the same or different construction as the active diaphragm b1-33. In some implementations of the embodiment, the passive diaphragm b1-35 may comprise a transparent or translucent material.

FIG. C1-1 depicts another particular, non-limiting embodiment of an LED-based illumination device in accordance with the teachings herein. The illumination device c1-01 depicted therein comprises a light-emitting portion c1-03 which emits light, and a connector module c1-05 which connects the illumination device c1-01 to the electrical outlet of a light fixture.

The illumination device c1-01 in this embodiment is equipped with a combination synthetic jet ejector/heat sink c1-29 which contains both a synthetic jet ejector c1-09 and a heat sink c1-27. These two components may be combined in a variety of ways, and each of these components, or the combination thereof, may have a variety of shapes or sizes. The two components may also comprise a variety of materials, though the heat sink c1-27 preferably comprises a thermally conductive material such as a metal (such as, for example, copper, aluminum, tin, steel, or various combinations or alloys thereof) or a thermally conductive loaded polymer. In the particular embodiment depicted, however, the heat sink c1-27 extends from one side of the synthetic jet ejector c1-09 and is adapted to direct synthetic jets c1-17 through channels c1-37 defined in the heat sink c1-27. Since the LED c1-15 is mounted on top of the heat sink c1-27 and is in thermal communication therewith, this arrangement transfers heat from the LED c1-15 to the atmosphere external to the illumination device c1-01.

In the embodiment depicted in FIG. C1-1, the light emitting portion c1-03 is preferably mounted on top of the heat sink c1-27 and may be open to the external atmosphere or may be vacuum sealed. Appropriate channels or conduits may be provided in the heat sink to accommodate any wires or circuitry associated with the LED c1-15. In some variations of this embodiment, however, the combination synthetic jet ejector/heat sink c1-29, the heat sink c1-27, or the synthetic jet ejector c1-09 may be disposed on an external surface of the illumination device c1-01. In such embodiments, if the heat sink c1-27 is disposed on an exterior surface of the illumination device c1-01, the LED c1-15 may be in thermal contact with the heat sink c1-27 through one or more heat pipes or other thermally conductive elements.

FIG. C2-1 depicts another particular, non-limiting embodiment of an LED-based illumination device in accordance with the teachings herein. The illumination device c2-01 depicted therein comprises a light-emitting portion c2-03 which emits light, and a connector module c2-05 which connects the illumination device c2-01 to the electrical outlet of a light fixture.

The illumination device c2-01 of this embodiment is similar in most respects to the illumination device c1-01 of FIG. C1-1 and hence is equipped with a combination synthetic jet ejector/heat sink c1-29 which contains both a synthetic jet ejector c1-09 and a heat sink c1-27. However, the illumination device c2-01 in this embodiment differs from the illumination device c1-01 of FIG. C1-1 in that the synthetic jet ejector c2-09 is centrally located. In some implementations, this type of embodiment may facilitate integration of the circuitry of the synthetic jet ejector c2-09 with the circuitry used to power the LED c2-15.

FIG. C3-1 depicts a further particular, non-limiting embodiment of an LED-based illumination device in accordance with the teachings herein. The illumination device c3-01 depicted therein comprises a light-emitting portion c3-03 which emits light, and a connector module c3-05 which connects the illumination device c3-01 to the electrical outlet of a light fixture.

In this embodiment, a heat sink c3-59 is disposed about the exterior of the light emitting portion c3-03 and the synthetic jet ejector c3-09 is disposed within the light emitting portion c3-03. However, the synthetic jet ejector c3-09 is in fluidic communication with the heat sink c3-59 by way of one or more channels c3-37. In the particular embodiment depicted, these channels c3-37 extend from the interior of the light emitting portion to the exterior of the light emitting portion c3-03, and are adapted to direct one or more synthetic jets across the surfaces of the heat sink c3-59 or the heat fins c3-27 thereof.

FIG. C4-1 depicts another particular, non-limiting embodiment of an LED-based illumination device in accordance with the teachings herein. The illumination device c4-01 depicted therein comprises a light-emitting portion c4-03 which emits light, and a connector module c4-05 which connects the illumination device c4-01 to the electrical outlet of a light fixture.

The illumination device c4-01 of this embodiment is similar in most respects to the illumination device c2-01 of FIG. C2-1 and hence is equipped with a combination synthetic jet ejector/heat sink c4-29 (shown in greater detail in FIG. C4-02) which contains both a synthetic jet actuator c4-07 and a heat sink c4-59. However, the illumination device c4-01 in this embodiment differs from the illumination device c1-01 of FIG. C2-1 in that the heat sink c4-27 is covered with a smooth exterior surface having a plurality of apertures c4-23 defined therein (see FIG. C4-1). These apertures c4-23 are in fluidic communication with the synthetic jet actuator c4-07 by way of channels c4-37 defined in the heat sink c4-27 (see FIG. C4-2). This type of embodiment may be advantageous in applications where the presence of exposed heat fins on the exterior of the illumination device c4-01 would be objectionable or undesirable.

FIGS. D1-1 to D1-2 depict a further particular, non-limiting embodiment of an LED-based illumination device in accordance with the teachings herein. The illumination device d1-01 depicted therein comprises a light-emitting portion d1-03 which emits light, and a connector module d1-05 which connects the illumination device d1-01 to the electrical outlet of a light fixture. A synthetic jet actuator d1-07 is disposed between the light emitting portion and the connector module d1-05.

This embodiment illustrates the application of the principles described herein to a popular type of compact fluorescent light bulb. The synthetic jet actuator d1-07 in this embodiment is equipped with a set of nozzles d1-41 which are adapted to direct a plurality of synthetic jets d1-17 across the surfaces, or into the interior of, the helical coil of the light emitting portion d1-03. The nozzles d1-41 are in fluidic communication with the interior of the synthetic jet actuator d1-07 where the diaphragms d1-13 are disposed, and the LEDs d1-15 which illuminate the light emitting portion d1-03 are disposed in, or adjacent to, this fluidic path.

In operation, the synthetic jet actuator d1-07 operates to create a fluidic flow adjacent to, or across the surfaces of, the LEDs d1-15, thereby removing heat from the LEDs and rejecting it to the external environment. The hot fluid is ejected as a synthetic jet d1-17, and hence is removed a significant distance from the nozzles d1-41. The synthetic jets also entrain cool air from the local environment and create a turbulent flow around the surfaces of the helix of the light emitting portion, thus helping to cool this portion of the illumination device d1-01 as well. The synthetic jets also draw in cool fluid around the nozzles d1-41, which is then drawn into the synthetic jet ejector during the in-flow phase of the diaphragms d1-13.

FIGS. D2-1 to D2-2 depict another particular, non-limiting embodiment of an LED-based illumination device in accordance with the teachings herein. The illumination device d2-01 depicted therein comprises a light-emitting portion d2-03 which emits light, and a connector module d2-05 which connects the illumination device d2-01 to the electrical outlet of a light fixture. A synthetic jet actuator d2-07 is disposed between the light emitting portion and the connector module d2-05.

The illumination device of FIGS. D2-1 to D2-2 is similar in many respects to the illumination device d1-01 of FIGS. D1-1 to D1-2. However, in the embodiment of FIGS. D2-1 to D2-2, the LEDs d2-15 are disposed at entrances to the helical light emitting portion d2-03, and the synthetic jet actuator d2-07 operates to direct synthetic jets d2-17 past the LEDs and into the light emitting portion d2-03. As best seen in FIG. D2-2, region d2-53 of the light emitting portion d2-03 is equipped with a series of apertures d2-23 which vent the fluidic flow to the external atmosphere. The vented flow may be in the form of one or more synthetic jets, but need not be so.

Various modifications may be made to the embodiment depicted in FIGS. D2-1 to D2-2. For example, in some variations, a single LED d2-15 may be utilized to generate light, and hence only one opening of the helix may be occupied by an LED d2-15. In some embodiments, two or more LEDs d2-15 may be provided which emit different wavelengths of light, and which provide color mixing for desired optical effects. In some embodiments, the apertures d2-23 may be disposed in any desired location on the light emitting portion d2-03.

FIG. D3-1 depicts another particular, non-limiting embodiment of an LED-based illumination device in accordance with the teachings herein. The illumination device d3-01 depicted therein comprises a light-emitting portion d3-03 which emits light, and a connector module d3-05 which connects the illumination device d3-01 to the electrical outlet of a light fixture. A synthetic jet actuator d3-07 is disposed between the light emitting portion and the connector module d3-05.

The illumination device d3-01 of FIG. D3-1 is similar in most respects to the illumination device of FIG. D1-1, but differs in the placement of the LEDs d3-39. In particular, in the embodiment depicted in FIG. D3-1, the LEDs d3-39 are disposed on the external surface of the helix of the light emitting portion d3-3. The synthetic jet actuator d3-07 operates to generate a fluidic flow which extends through the coils of the light emitting portion d3-03, and exits through nozzles d3-41 in the form of synthetic jets d3-17. Hence, this embodiment operates to cool the substrate the LED d3-39 is disposed on, as well as the light emitting surface of the LED d3-39.

In some variations of this embodiment, the helical coils of the light emitting portion d3-03 may comprise a suitably thermally conductive material. Such a material may provide for more efficient transfer of heat from the LEDs d3-39 to the underlying substrate, where it may be rejected to the external atmosphere by the fluidic flow created by the synthetic jet actuator d3-07. In other variations, the LEDs d3-39 may be directed inward so that their backsides are exposed to the internal environment, and their light emitting surfaces are directed towards the interior of the helical coil. In these different embodiments, a metallic interconnect may be disposed on the interior or exterior surface of the coils, or may be embedded in the walls of the coils.

FIG. E1-1 depicts another particular, non-limiting embodiment of an LED-based illumination device in accordance with the teachings herein. The illumination device e1-01 depicted therein comprises a light-emitting portion e1-03 which emits light, and a connector module e1-05 which connects the illumination device e1-01 to the electrical outlet of a light fixture. A synthetic jet actuator e1-07 is disposed between the light emitting portion and the connector module e1-05.

In this embodiment, the synthetic jet actuator e1-07 is centrally disposed within the light emitting portion e1-03, and a plurality of LEDs e1-15 are disposed around it. A heat sink e1-59 is built into the base of the illumination device e1-01, and is equipped with channels e1-37 which are in fluidic communication with the synthetic jet actuator e1-07. During operation, the synthetic jet actuator e1-07 creates a fluidic flow which preferably includes synthetic jets e1-17, and which rejects heat from the heat sink e1-59 to the external environment.

As indicated in FIG. E1-1, the surfaces of the illumination device e1-01 in the vicinity of the LEDs e1-15 may be covered with a suitable reflective material e1-45. The amount of the surface area so coated may be determined, for example, by the desired illumination profile of the illumination device e1-01. Notably, the design of this illumination device e1-01 also allows for the use of relatively large diaphragms e1-13 in the synthetic jet actuator e1-07, which may be useful in achieving high heat flux from the heat sink e1-59 to the external environment.

FIG. E2-1 depicts another particular, non-limiting embodiment of an LED-based illumination device in accordance with the teachings herein. The illumination device e2-01 depicted therein comprises a light-emitting portion e2-03 which emits light, and a connector module e2-05 which connects the illumination device e2-01 to the electrical outlet of a light fixture. A synthetic jet ejector e2-09 is disposed between the light emitting portion and the connector module e2-05.

One wall of the synthetic jet ejector e2-09 is equipped with a heat sink e2-59 comprising a plurality of heat fins e2-27. The heat fins e2-27 are disposed adjacent to an LED e2-15 and define a plurality of channels e2-37 which are in fluidic communication with the interior of the synthetic jet ejector e2-09.

During operation, the heat sink e2-59 absorbs heat from the LEDs e2-15, and the synthetic jet ejector e2-09 generates a plurality of synthetic jets e2-17 in the channels e2-37 which transfers the heat to the interior environment of the light emitting portion e2-03. From there, the heat is rejected to the external environment through thermal transfer. In some implementations, thermal transfer to the external environment may be facilitated by the provision of suitable venting in the light emitting portion e2-03 or by other suitable means. As with the previous embodiment, the design of this illumination device e2-01 allows for the use of relatively large diaphragms e2-13 in the synthetic jet ejector e2-09, which may be useful in achieving high heat flux from the heat sink e2-59 to the external environment.

FIG. E3-1 depicts another particular, non-limiting embodiment of an LED-based illumination device in accordance with the teachings herein. The illumination device e3-01 depicted therein comprises a light-emitting portion e3-03 which emits light, and a connector module e3-05 which connects the illumination device e3-01 to the electrical outlet of a light fixture. A synthetic jet ejector e3-09 is disposed between the light emitting portion and the connector module e3-05.

In this embodiment, the synthetic jet ejector e3-09 is centrally disposed within a heat sink e3-59 having a plurality of external heat fins e3-27. The external heat fins e3-27 have a plurality of channels e3-37 defined therein which are in fluidic communication with the interior of the synthetic jet ejector e3-09 and the external environment. An LED e3-15 is disposed on top of the heat sink.

In operation, the heat sink e3-59 absorbs heat given off by the LED e3-15, and this heat is transferred to the heat fins e3-27. The synthetic jet ejector e3-09 creates a plurality of synthetic jets e3-17 in the channels e3-37 which rejects the heat to the external environment. As with the previous embodiment, the design of this illumination device e3-01 allows for the use of relatively large diaphragms e3-13 in the synthetic jet ejector e3-09, which may be useful in achieving high heat flux from the heat sink e3-59 to the external environment.

FIG. E4-1 depicts another particular, non-limiting embodiment of an LED-based illumination device in accordance with the teachings herein. The illumination device e4-01 depicted therein comprises a light-emitting portion e4-03 which emits light, and a connector module e4-05 which connects the illumination device e4-01 to the electrical outlet of a light fixture. A synthetic jet ejector e4-09 is disposed between the light emitting portion and the connector module e4-05.

In this embodiment, the synthetic jet ejector e4-09 is centrally disposed within a heat sink e4-59 having a plurality of external heat fins e4-27. The portion of the heat sink e4-59 which separates the light emitting portion e4-03 from the heat fins e4-27 is porous, and hence provides for fluidic flow between the interior of the light emitting portion e4-03 and the external environment as indicated by arrows e4-63. This may be achieved, for example, by forming this portion of the heat sink e4-59 out of a foamed, thermally conductive material, such as a foamed metal, or by providing a plurality of apertures or vents in this portion of the heat sink e4-59. An LED e4-15 is disposed on top of the heat sink e4-59.

Similarly, the interior of the light emitting portion e4-03 is in fluidic communication with the interior of the synthetic jet ejector e4-09. This may be accomplished, for example, by seating the LED e4-15 on a metal plate or heat spreader which is in thermal contact with the heat fins e4-27, and which has a plurality of apertures e4-37 therein adjacent to the LED e4-15 which are in fluidic communication with the interior of the synthetic jet ejector e4-09.

In operation, the heat sink e4-59 absorbs heat given off by the LED e4-15, and this heat is transferred to the heat fins e4-47. The synthetic jet ejector e4-09 emits a plurality of synthetic jets e4-17 from the channels e4-37, which in turn creates a flow of fluid across the heat fins e4-27. The synthetic jets e4-17 also facilitate the transfer of heat from the LED e4-15 to the interior atmosphere of the light emitting portion e4-03, where the warmed fluid can then exit the light emitting portion e4-03 to the external environment as indicated by the arrows e4-63. This fluidic flow also facilitates the transfer of heat from the heat fins e4-27 to the external environment. As with the previous embodiment, the design of this illumination device e4-01 allows for the use of relatively large diaphragms e4-13 in the synthetic jet ejector e4-09, which may be useful in achieving high heat flux from the heat sink e4-59 to the external environment.

FIG. F1-1 depicts a further particular, non-limiting embodiment of an LED-based illumination device in accordance with the teachings herein. The illumination device f1-01 depicted therein comprises a light-emitting portion f1-03 which emits light, and a connector module f1-05 which connects the illumination device f1-01 to the electrical outlet of a light fixture. A synthetic jet actuator f1-07 is disposed between the light emitting portion f1-03 and the connector module f1-05.

The illumination device f1-01 in this embodiment is equipped with a heat sink f1-59 comprising a plurality of heat fins f1-27, and upon which is disposed an LED f1-15. The illumination device f1-01 comprises an interior housing element f1-55 and an exterior housing element f1-57 which, between them, define a channel f1-37 for fluidic flow. The channel f1-37 is in fluidic communication with the synthetic jet actuator f1-07 by way of a series of internal apertures f1-09, and is further in fluidic communication with a plurality of nozzles f1-41 disposed about the interior of the light emitting portion f1-03.

In operation, the synthetic jet actuator f1-07, which is driven by one or more diaphragms f1-13, creates a plurality of synthetic jets f1-17 at the nozzles f1-41. The synthetic jets f1-17 are directed at, or across, the surfaces of the LED f1-15, and especially the light emitting surface thereon. The synthetic jets f1-17 facilitate the transfer of heat from the LED f1-15 to the interior atmosphere of the light emitting portion f1-03, where it can be dissipated through thermal transfer to the internal f1-55 and external f1-57 housing elements and to the external environment, or through absorption by the heat sink f1-59. The heat sink f1-59 serves to absorb heat directly from the backside of the LED f1-15. In some implementations of this embodiment, the heat sink f1-59 may be equipped with one or more heat pipes.

FIG. G1-1 depicts a further particular, non-limiting embodiment of an LED-based illumination device in accordance with the teachings herein. The illumination device g1-01 depicted therein comprises a light-emitting portion g1-03 which emits light, a connector module g1-05 which connects the illumination device g1-01 to the electrical outlet of a light fixture, and a heat sink g1-59 disposed between the two. A synthetic jet ejector g1-09 equipped with a set of diaphragms g1-13 is disposed in a central, internal chamber g1-51 in the light emitting portion g1-03 of the illumination device g1-01. The internal chamber g1-51 has a reflective surface g1-45. A plurality of LEDs g1-15 are disposed on the heat sink g1-59 in the volume between the internal chamber g1-45 and the exterior wall of the light emitting portion g1-03.

In operation, the light emitted from the LEDs g1-15 is reflected off of the reflective surface g1-45 and is emitted through the exterior wall of the light emitting portion g1-03. The degree of specular or diffuse reflectivity of these two surfaces may be selected to achieve a desired illumination footprint. Heat is withdrawn from the LEDs g1-15 by the heat sink g1-59. The synthetic jet ejector g1-09 creates a fluidic flow across the surfaces of the heat fins g1-27 as indicated by the arrows g1-63, thus rejecting the heat to the external environment. Preferably, this flow g1-63 is in the form of one or more synthetic jets.

FIG. G1-2 depicts another particular, non-limiting embodiment of an LED-based illumination device in accordance with the teachings herein. The illumination device g2-01 depicted therein comprises a light-emitting portion g2-03 which emits light, and a synthetic jet ejector g2-09. The remaining elements of the illumination device have been omitted for clarity of illustration, but would typically include an electrical connector module and the operating components of the synthetic jet ejector g2-09. The illumination device g2-01 includes a heat spreader g2-65 with a plurality of apertures g2-19 defined therein. The globe g2-57 of the light emitting portion g2-03 is provided with a centrally disposed depression g2-51 therein.

In use, the synthetic jet ejector g2-09 creates a plurality of synthetic jets g2-17 in the vicinity of the LED g2-15. The synthetic jets impinge on the surface of the depression g2-51, and thus aid in the transfer of heat from the interior of the light emitting portion g2-03 to the external environment.

FIG. H1-1 depicts another particular, non-limiting embodiment of an LED-based illumination device in accordance with the teachings herein, which in this case is a tubular illumination device similar to the type used in fluorescent lamps. The illumination device h1-01 depicted therein comprises a light-emitting portion h1-03 which emits light, and a synthetic jet actuator h1-09 equipped with a set of diaphragms h1-13. An LED g1-15 is disposed at each end of the tubing h1-57 forming the light emitting portion h1-03, and has a set of apertures h1-19 disposed adjacent thereto which permit a fluidic flow about the LED h1-13 and into the tubing h1-57 of the light emitting portion h1-03.

In operation, the synthetic jet ejector h1-09 creates a fluidic flow about the LEDs h1-15 in the form of one or more synthetic jets h1-17. This flow transfers heat from the LEDs h1-13 to the surfaces of the tubing h1-57 of the light emitting portion h1-03, where it is rejected to the external atmosphere.

FIG. H2-1 depicts another particular, non-limiting embodiment of an LED-based illumination device in accordance with the teachings herein. The illumination device h2-01 depicted therein is similar in most respects to the embodiment depicted in FIG. H1-1, and hence comprises a light-emitting portion h2-03 which emits light, and a synthetic jet actuator h2-09 equipped with a set of diaphragms h2-13. An LED h2-15 is disposed at each end of the tubing h2-57 forming the light emitting portion h2-03, and has a set of apertures h2-19 disposed adjacent thereto which permit a fluidic flow about the LED h2-15 and into the tubing h2-57 of the light emitting portion h2-03. In addition, however, the illumination device h2-01 of this embodiment is equipped with a passive diaphragm h2-35 which operates in a manner similar the passive diaphragm b1-35 in the embodiment of FIG. B1-1.

In operation, the synthetic jet ejector h2-09 creates a fluidic flow about the LEDs h2-15 in the form of one or more synthetic jets h2-17. This flow transfers heat from the LEDs h2-15 to the surfaces of the tubing h2-57 of the light emitting portion h2-03, where it is rejected to the external atmosphere.

FIG. H3-1 depicts another particular, non-limiting embodiment of an LED-based illumination device in accordance with the teachings herein. The illumination device h3-01 depicted therein is similar in most respects to the embodiment depicted in FIG. H1-1, and hence comprises a light-emitting portion h3-03 which emits light, and a synthetic jet actuator h3-09 equipped with a set of diaphragms h3-13. An LED h3-15 is disposed at each end of the tubing h3-57 forming the light emitting portion h3-03, and has a set of apertures h3-19 disposed adjacent thereto which permit a fluidic flow about the LED h3-15 and into the tubing h3-57 of the light emitting portion h3-03. In addition, however, this embodiment is equipped with an external vent h3-23 disposed in a central location on the tubing h3-57 which forms the light emitting portion h3-03.

In operation, the synthetic jet ejector h3-09 creates a fluidic flow about the LEDs h3-15 in the form of one or more synthetic jets h3-17. This flow transfers heat from the LEDs h3-15 to the surfaces of the tubing h3-57 of the light emitting portion h3-03, where it is rejected to the external atmosphere. The external vent h3-23 provides an additional means by which heat may be rejected to the external environment.

In some variations of this embodiment, the illumination device h2-01 may be adapted to emit synthetic jets from the external vent h3-23. In other variations, the synthetic jet ejector provides a fluidic flow around the LEDs h3-15, but only emits synthetic jets at the external vent h3-23.

### Reflective Materials

The various embodiments of light fixtures disclosed herein may be equipped with various reflective materials or surfaces. These include, without limitation, specularly or diffusely reflective or scattering materials. Such materials may be applied to the intended substrate as coatings or films. In some implementations, these coatings or films may be formed and then applied to the substrate, while in other implementations, they may be formed on the substrate in situ.

Examples of such scattering films include those based on continuous/disperse phase materials. Such films may be formed, for example, from a disperse phase of polymeric particles disposed within a continuous polymeric matrix. In some embodiments, one or both of the continuous and disperse phases may be birefringent. Such a film may be oriented, typically by stretching, in one or more directions. The size and shape of the disperse phase particles, the volume fraction of the disperse phase, the film thickness, and the amount of orientation may be chosen to attain a desired degree of diffuse reflection and total transmission of electromagnetic radiation of a desired wavelength in the resulting film. Films of this type, and methods for making them, are described, for example, in U.S. Pat. No. 6,031,665 (Carlson et al.), which is incorporated herein by reference in its entirety. Analogous films in which the disperse phase comprises inorganic or non-polymeric materials (such as, for example, silica, alumina, or metal particles) may also be utilized in the devices and methodologies described herein.

Reflective surfaces may also be imparted to the devices described herein through suitable metallization. These include, for example, films of silver or other metals which may be formed through vapor or electrochemical deposition.

### Electrical Outlets

The various embodiments of light fixtures disclosed herein may be equipped with various electrical connectors. These include, without limitation, threaded connectors that rotatingly engage complimentary shaped sockets in an electrical outlet; prong connectors, which may be male or female, and which mate with complimentary shaped prongs or receptacles in an electrical outlet; cord connectors; and the like. The choice of connector may vary from one application to another and may depend, for example, on the wattage output of the light fixture and other such considerations as are known to the art. It will be understood, however, that while embodiments of light fixtures may have been disclosed or illustrated herein as having a particular connector type, any other suitable connector, including those described above, may be substituted where suitable for a particular application.

### Bulb Coatings/Pigments

The various embodiments of light fixtures disclosed herein may be equipped with various bulbs. These bulbs, or any portion thereof, may be clear, opaque, specularly or diffusively transmissive, specularly or diffusively reflective, polarizing, mirrored, colored, or any combination of the foregoing. In some embodiments, the bulb may also be equipped with a film or pigment which provides the light fixture with a desired optical footprint. These bulbs may also be equipped with any of the various types of phosphors as are known to the art, or with various combinations of such phosphors.

### Synthetic Jet Actuators/Ejectors

Various synthetic jet actuators and synthetic jet ejectors may be utilized in the devices and methodologies described herein. Preferably, however, the synthetic jet actuators and synthetic jet ejectors are of the type described in U.S. Ser. No. 61/304427, entitled “SYNTHETIC JET EJECTOR AND DESIGN THEREOF TO FACILITATE MASS PRODUCTION” (Grimm et al.), which is incorporated herein by reference in its entirety. These synthetic jet actuators and synthetic jet ejectors may have various sizes, dimensions and geometries, and hence may be adapted to spaces available in the host device. Hence, for example, the synthetic jet ejector may be cylindrical, parallelepiped, or irregular in shape.

FIG. I-1 depicts a particular, non-limiting embodiment of such a synthetic jet ejector i1-09 and its application in an illumination device i1-01. The illumination device i1-01 comprises a light-emitting portion i1-03, a heat sink i1-59 (which, in this embodiment, is integral with the housing) having a synthetic jet actuator i1-07 (see FIG. I1-2) disposed therein, an upper wall i1-75, a lower wall i1-76, and a base i1-79.

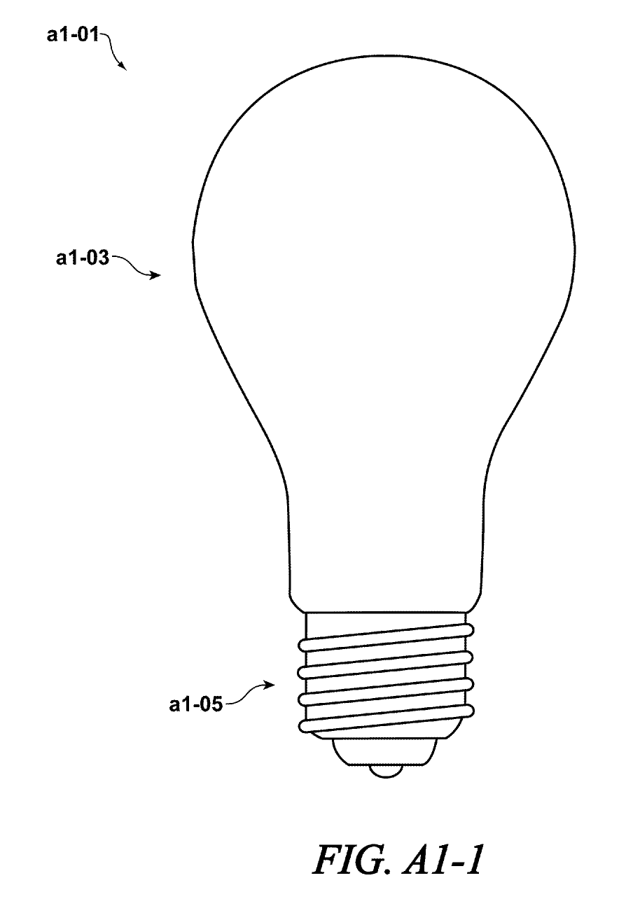

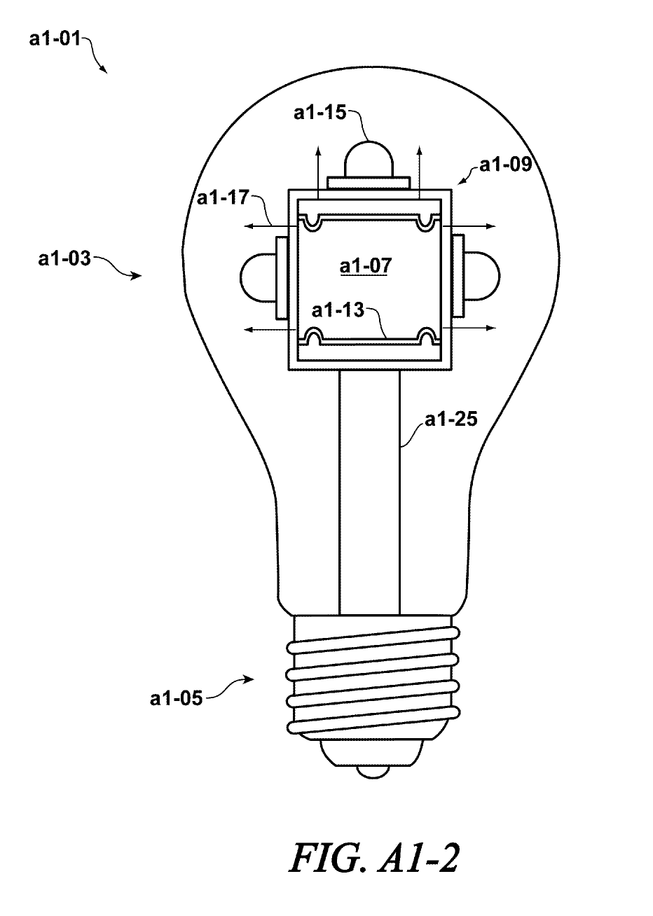

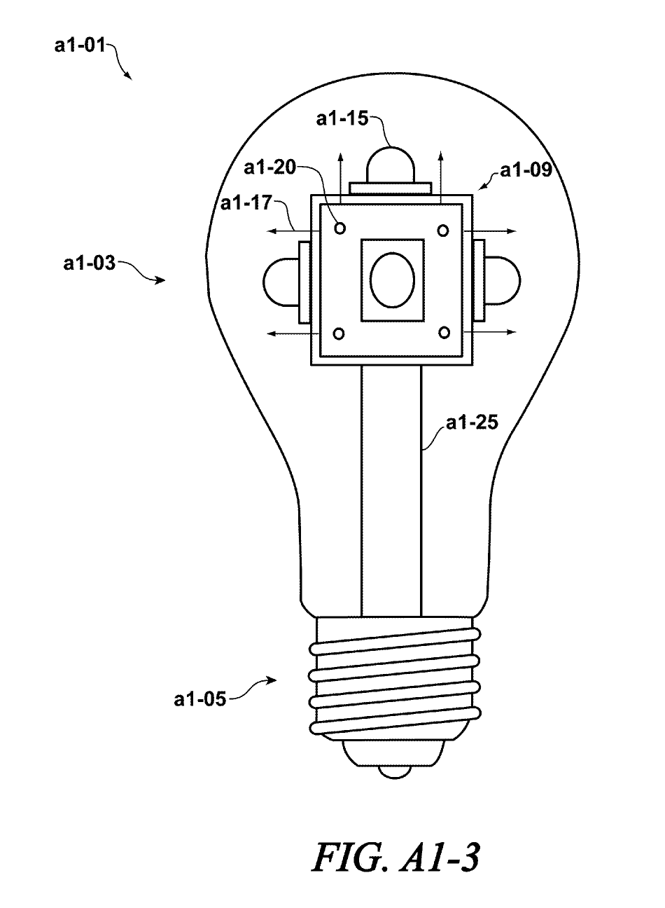

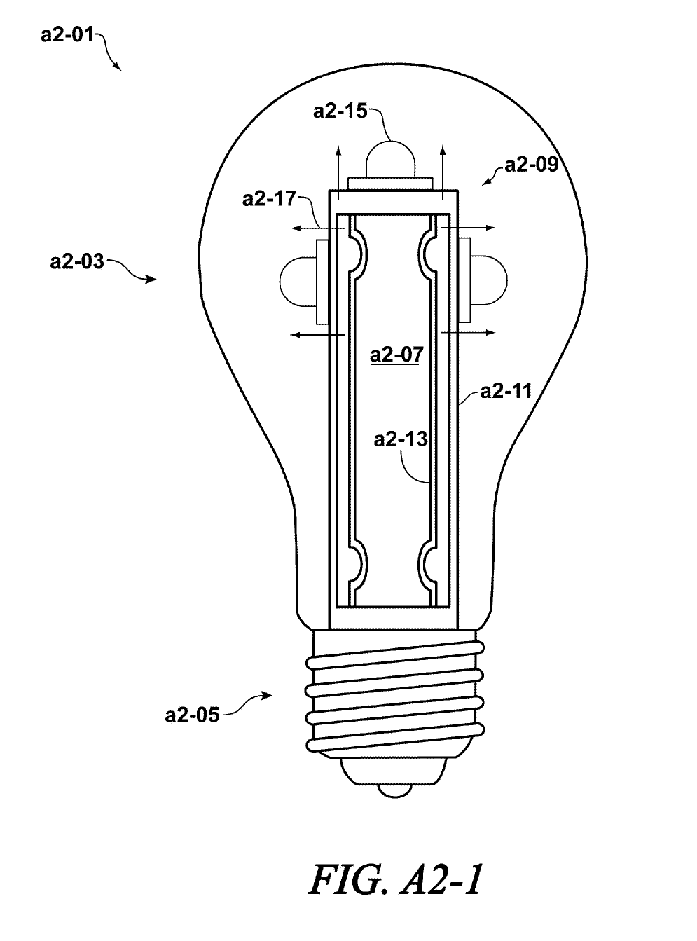

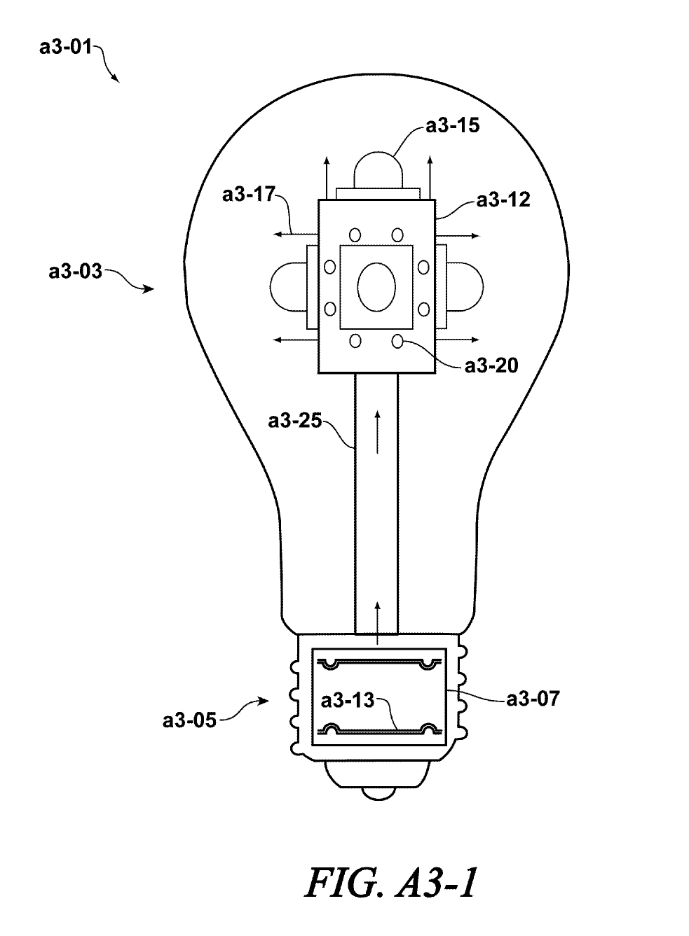

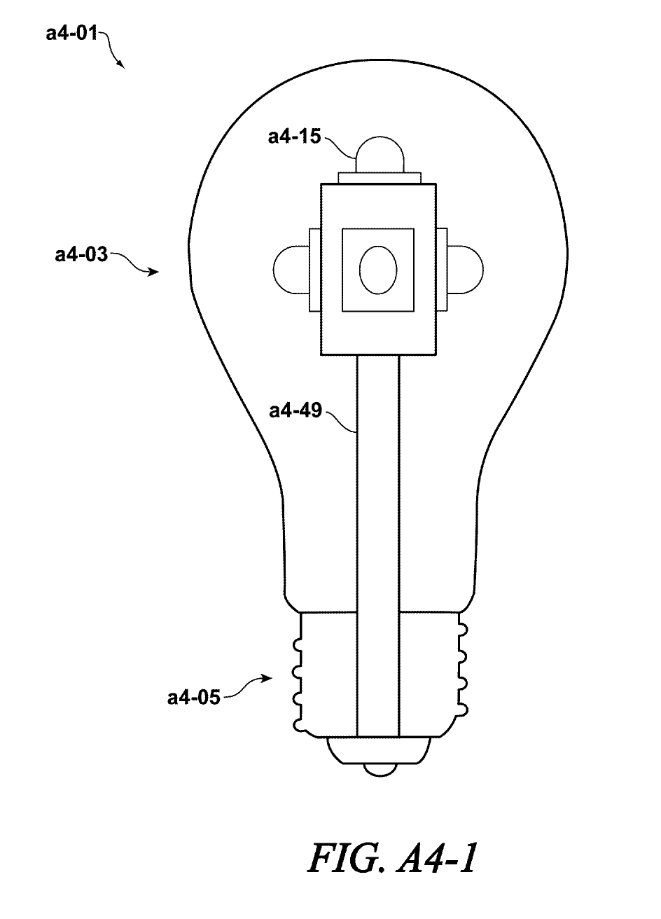

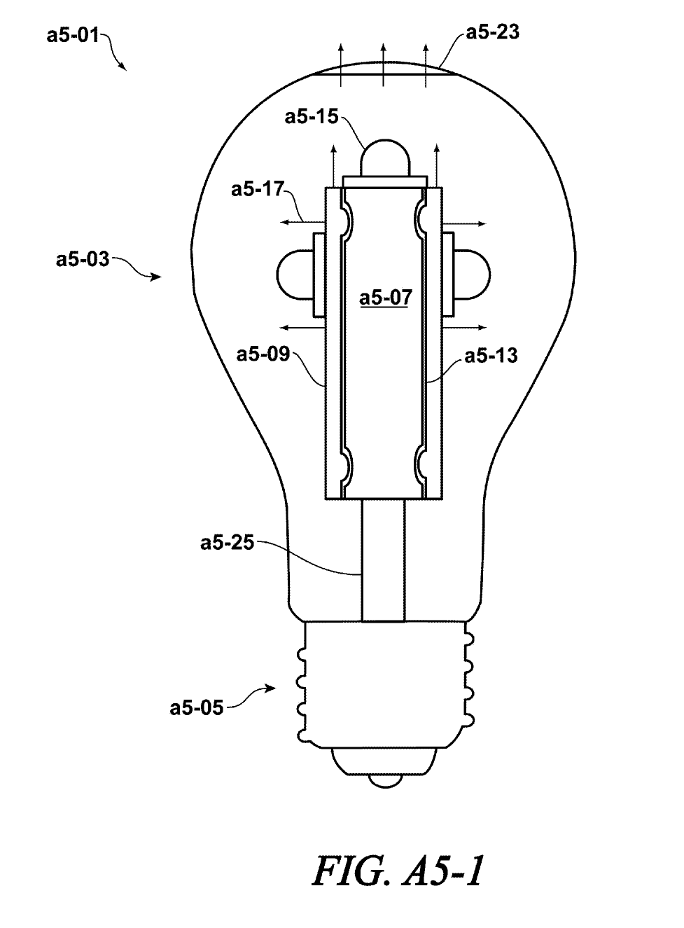

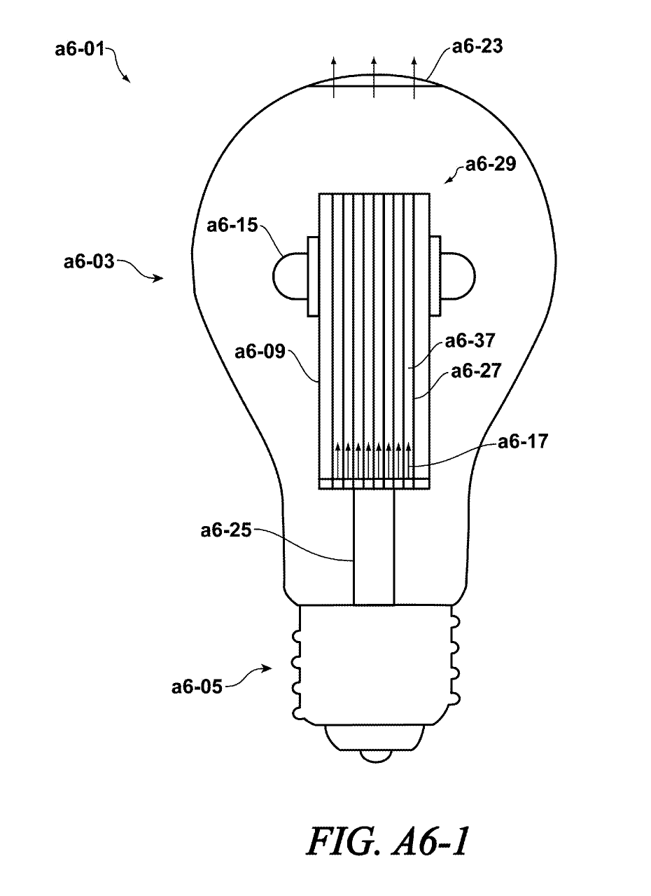

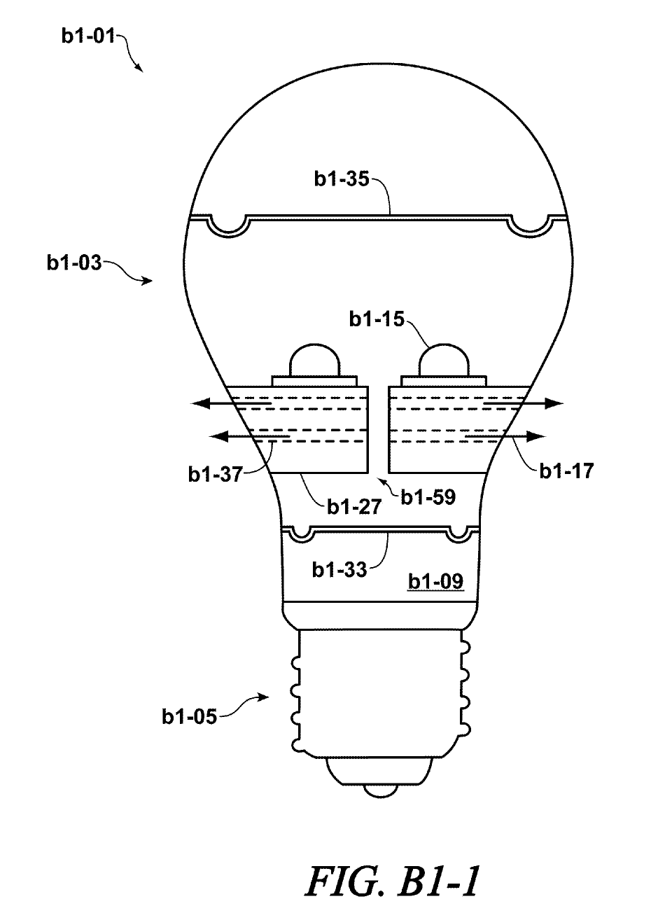

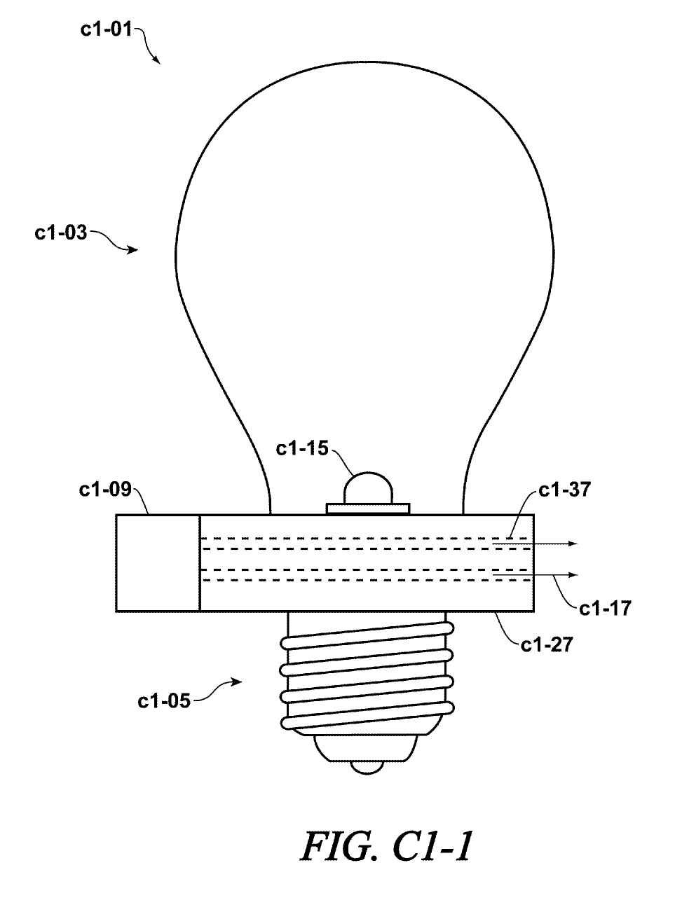

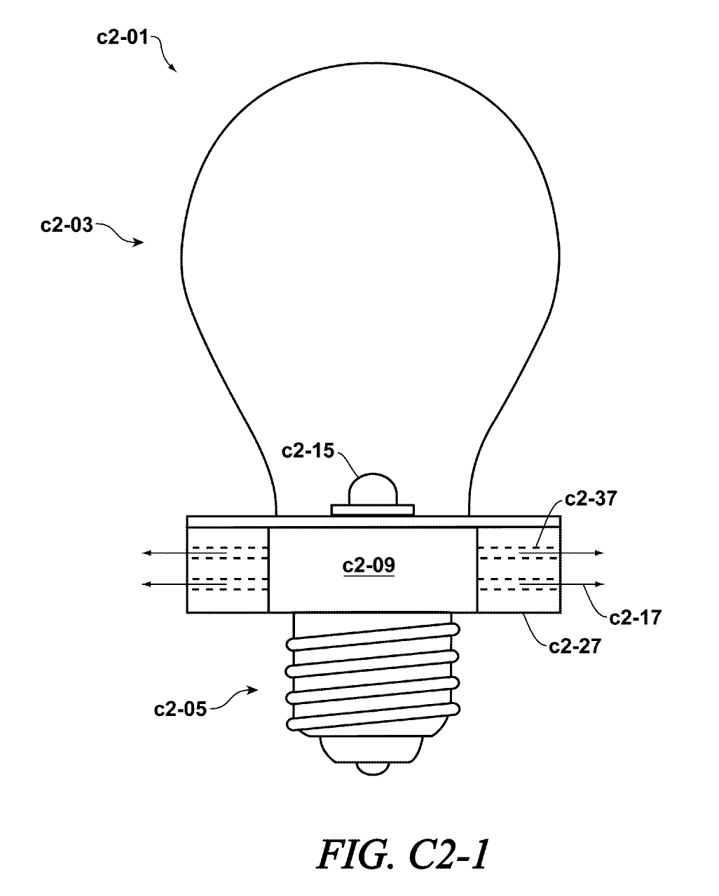

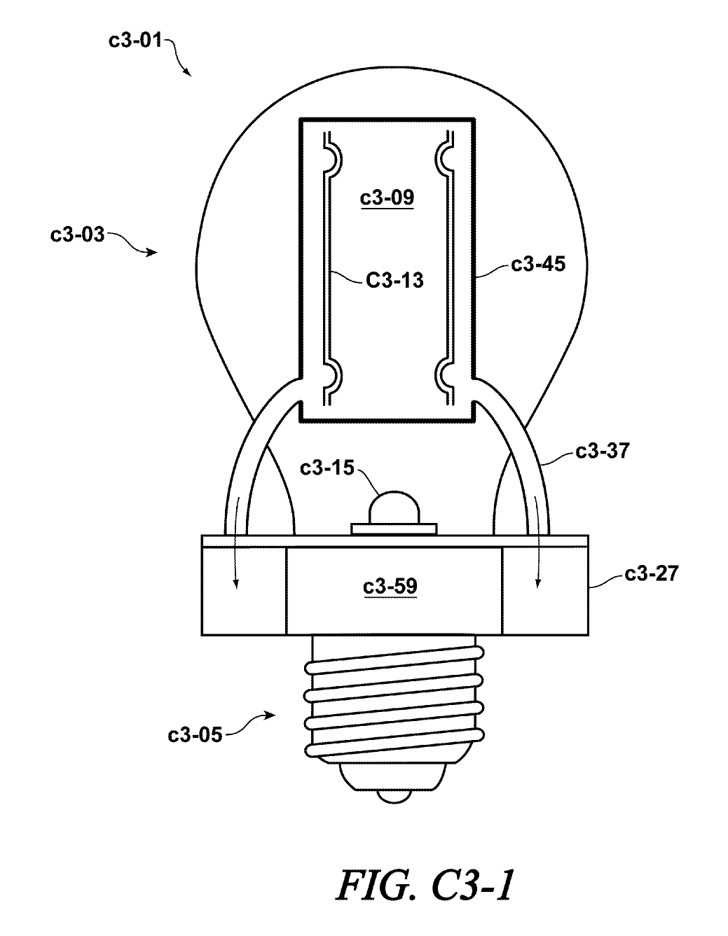

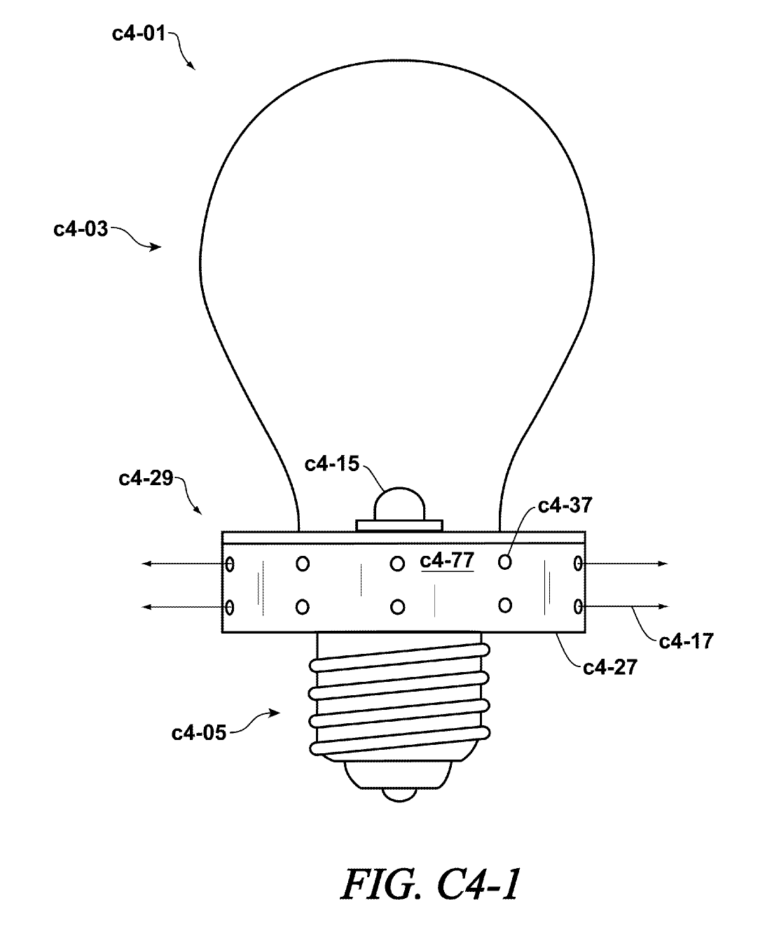

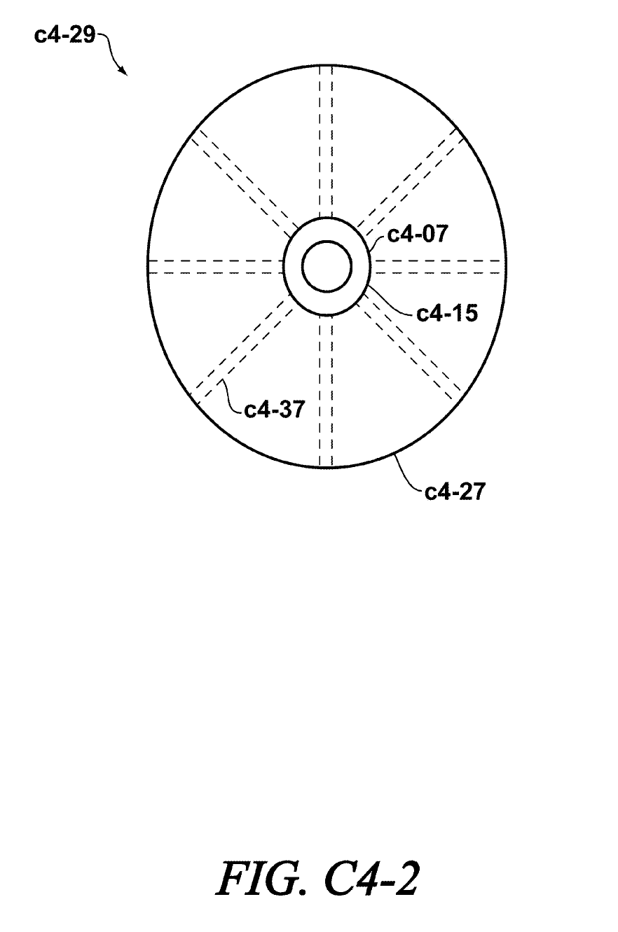

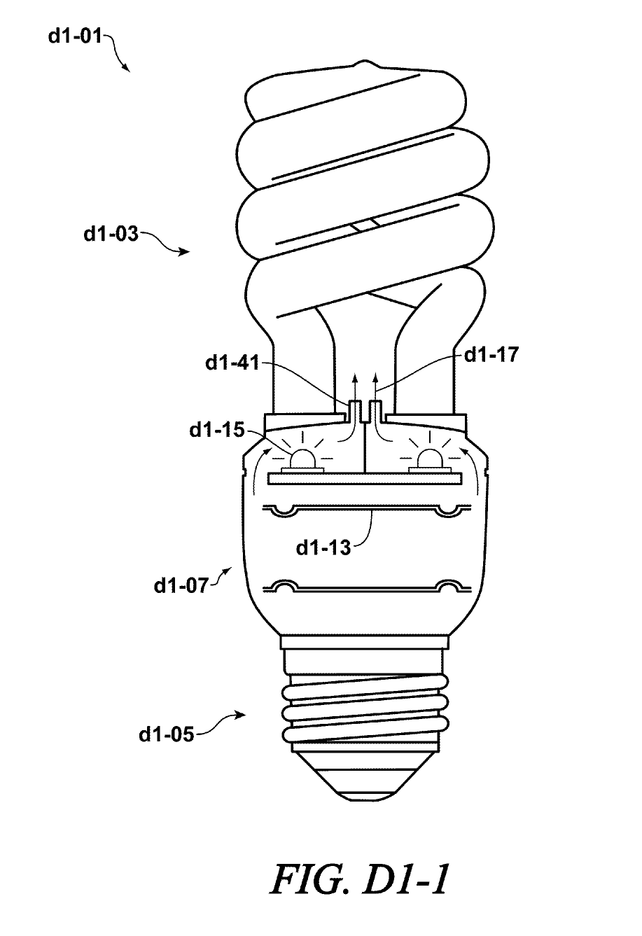

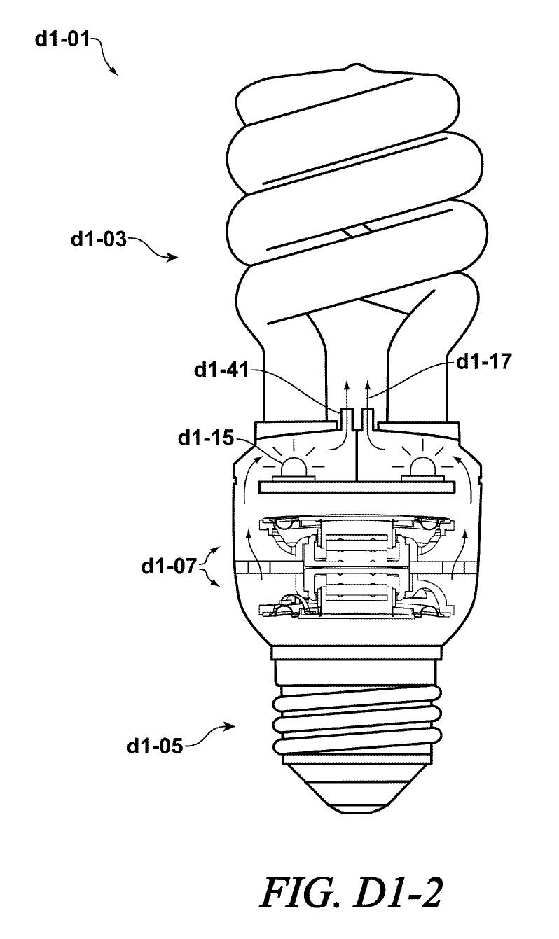

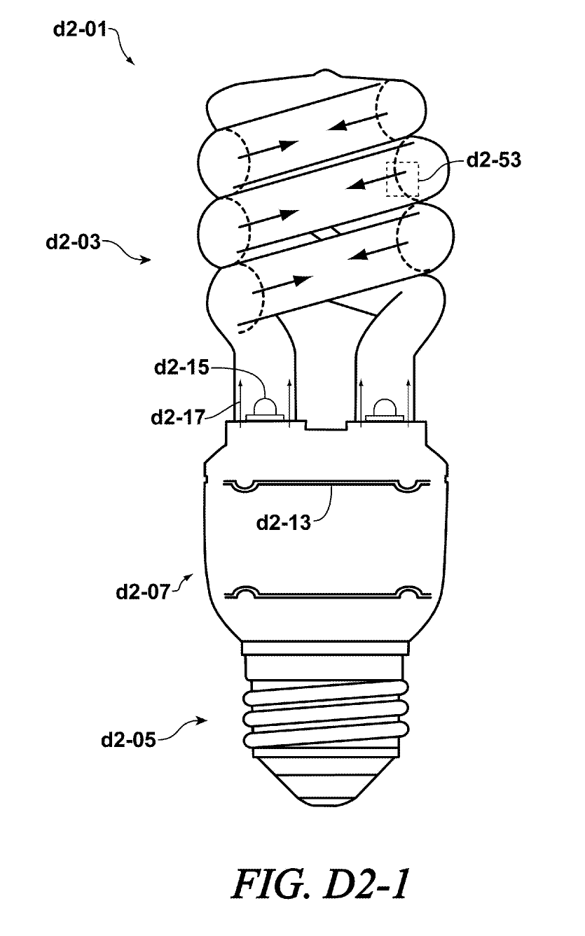

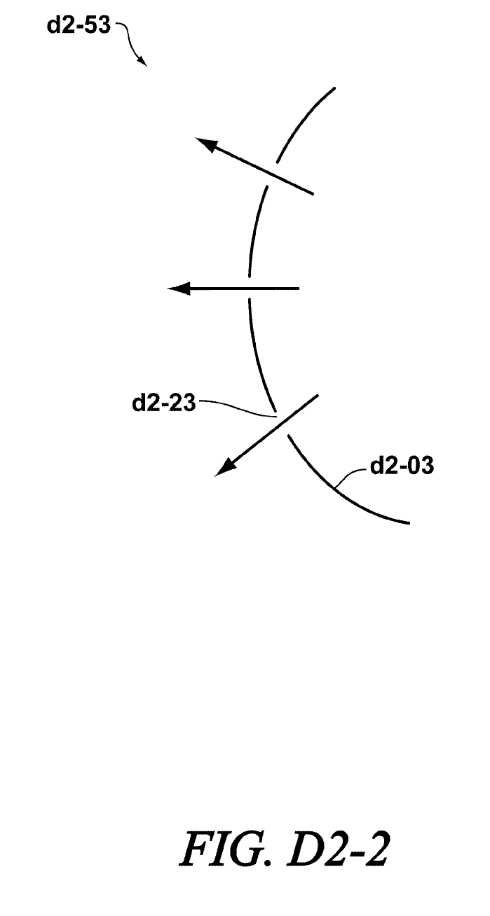

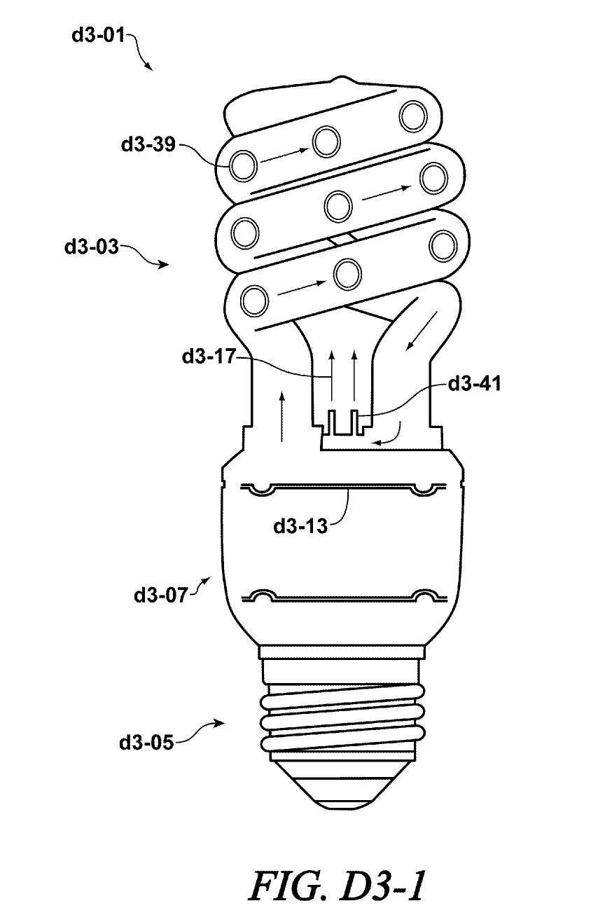

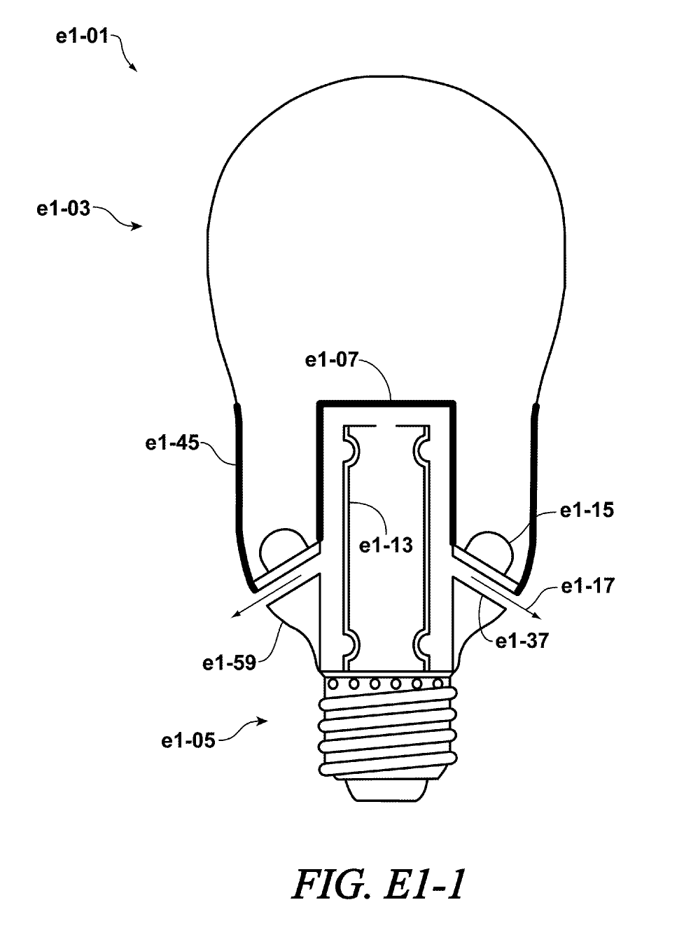

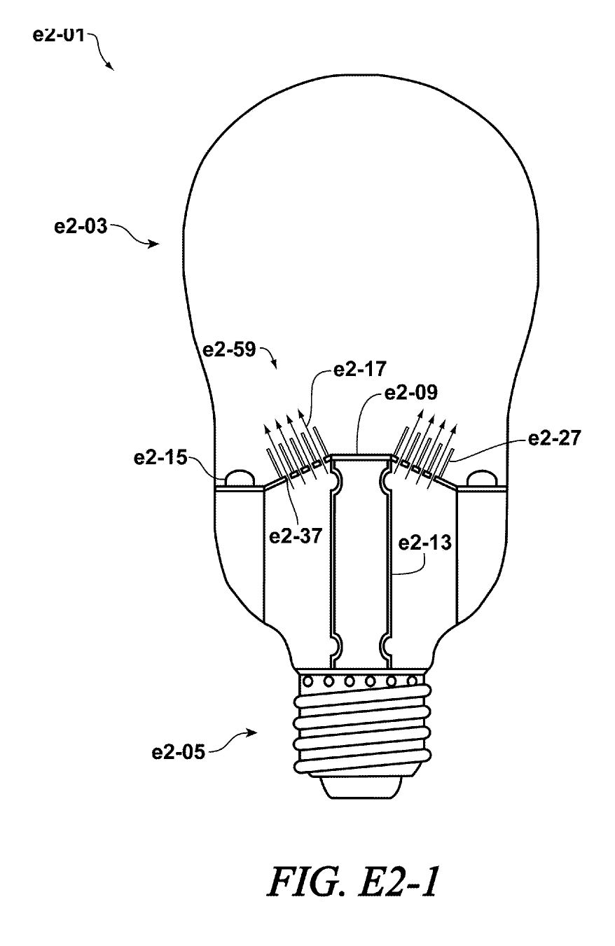

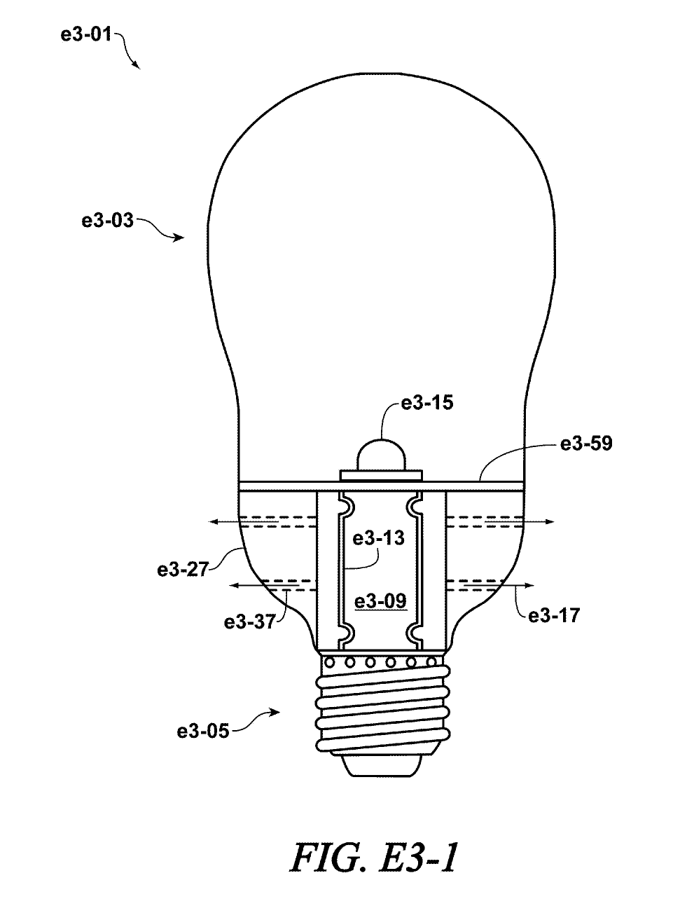

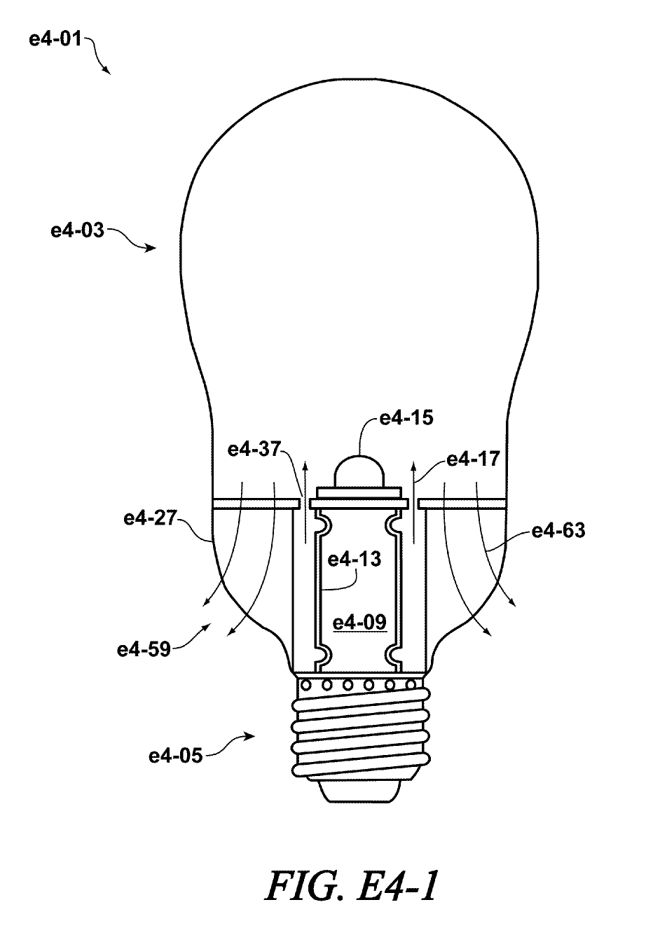

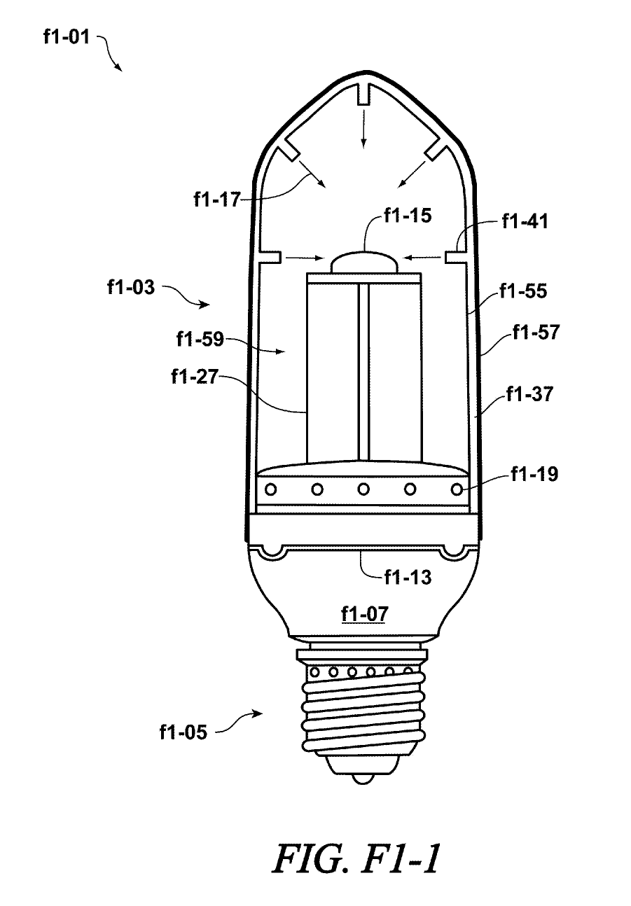

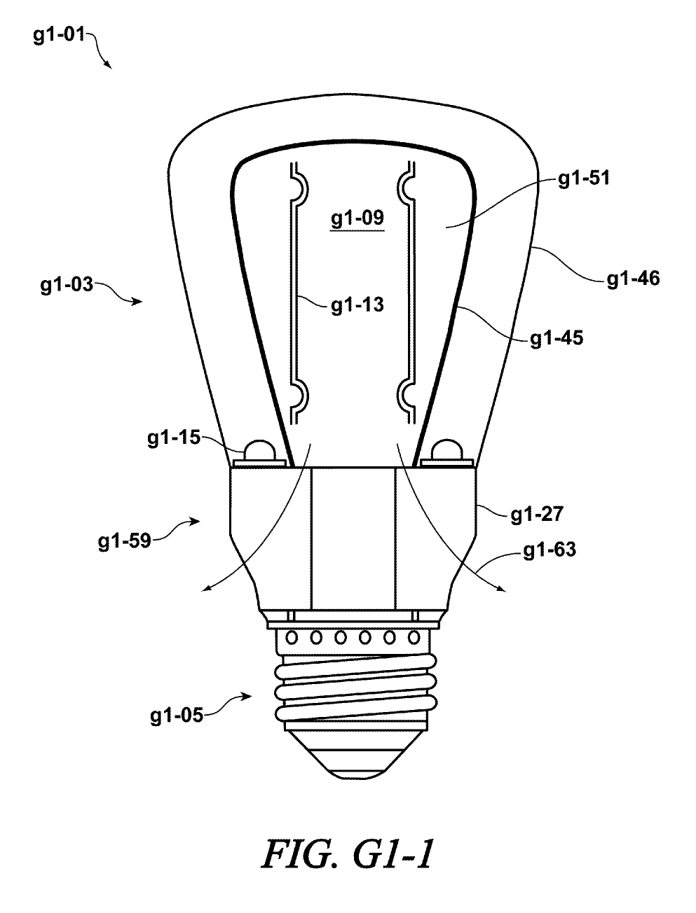

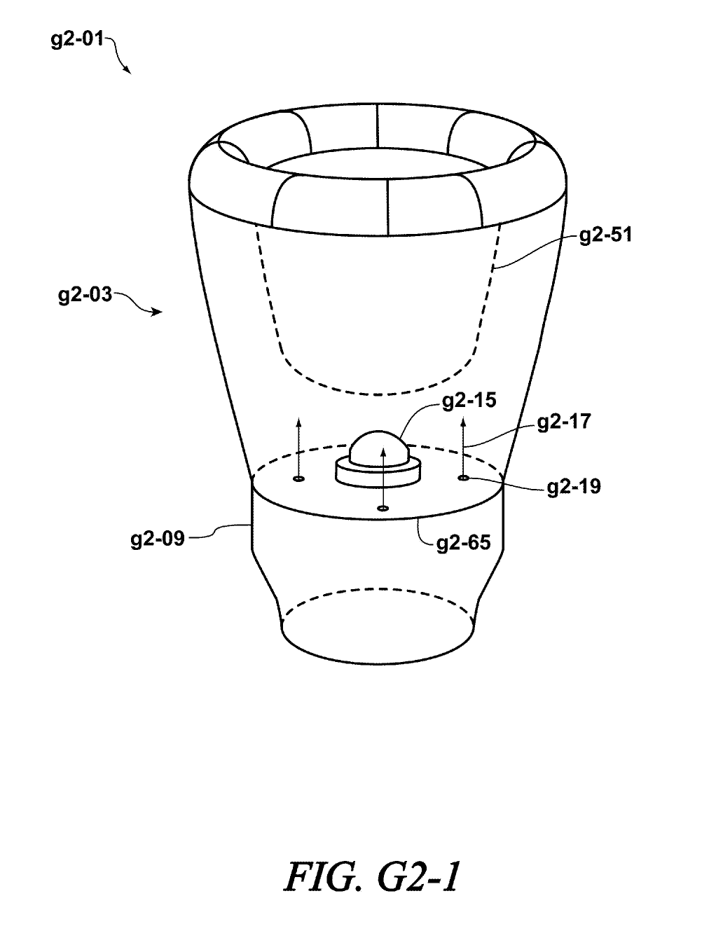

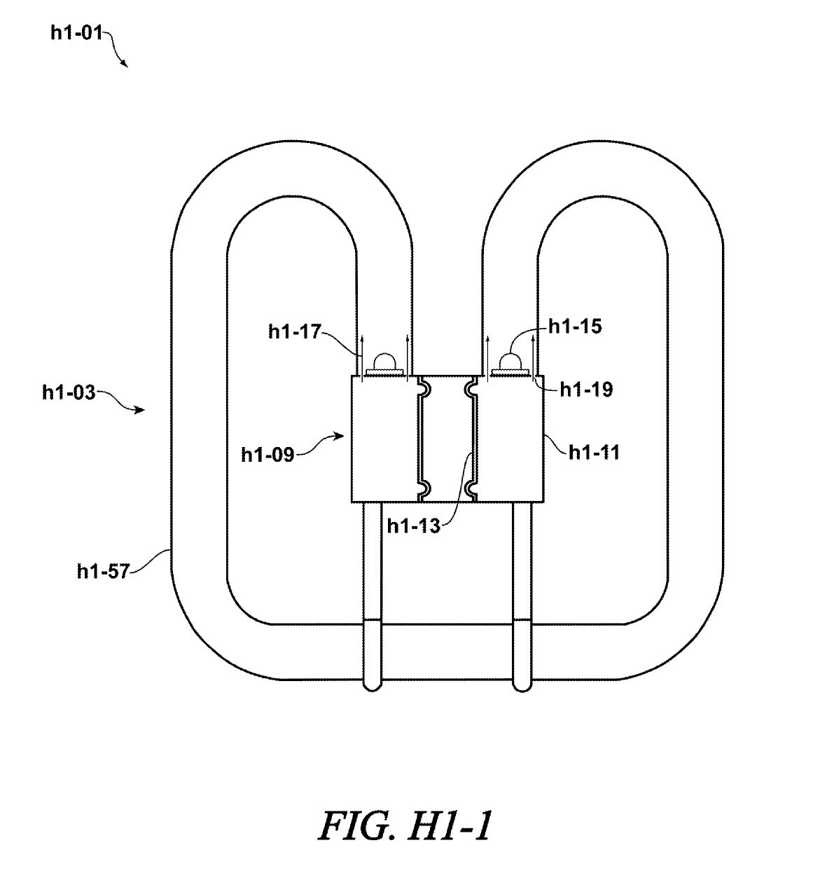

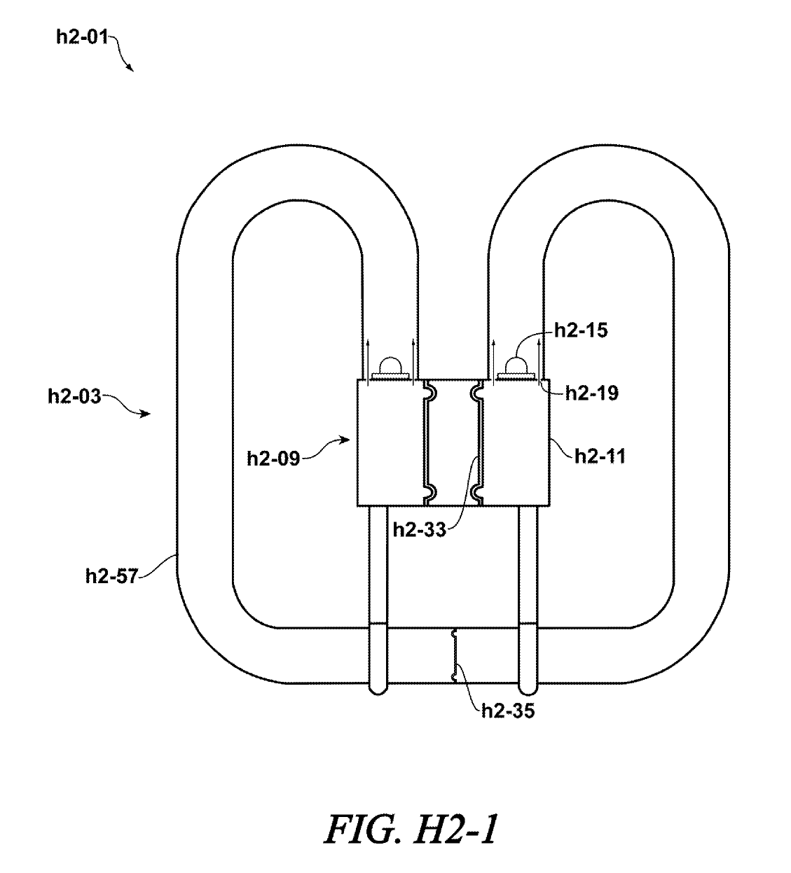

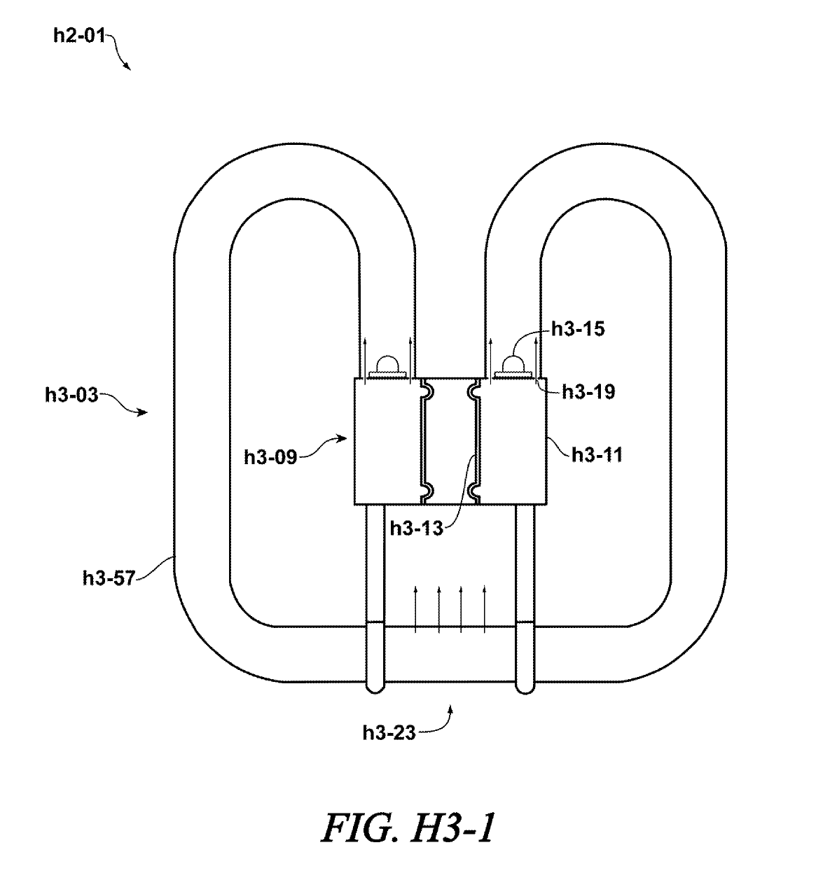

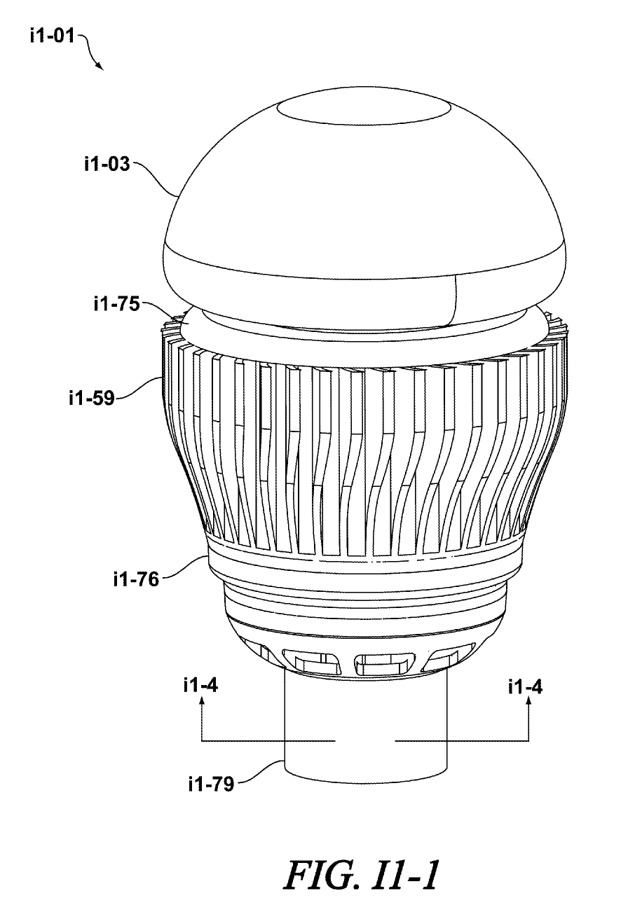

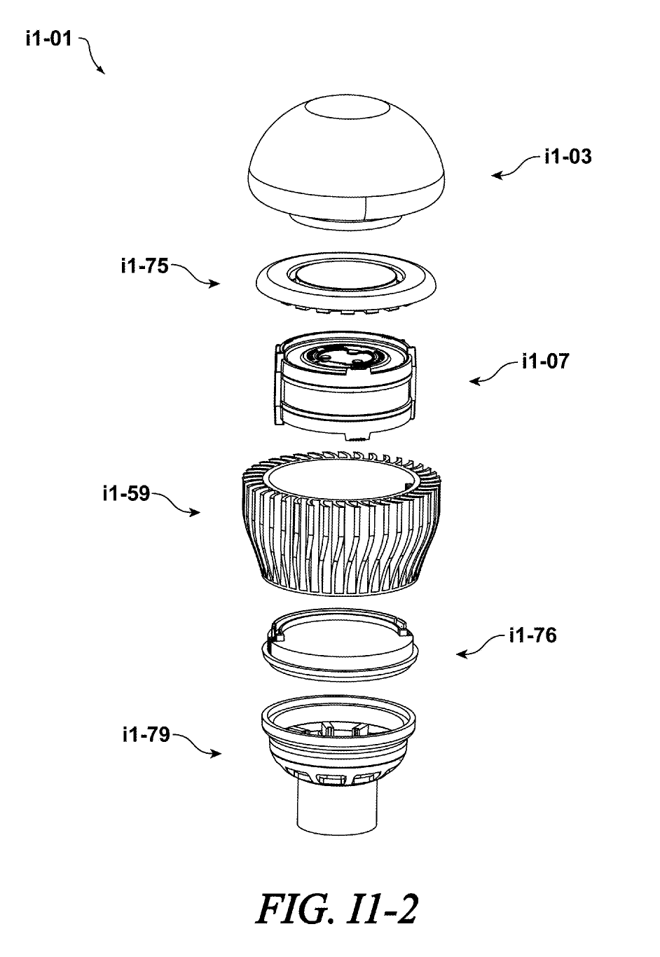

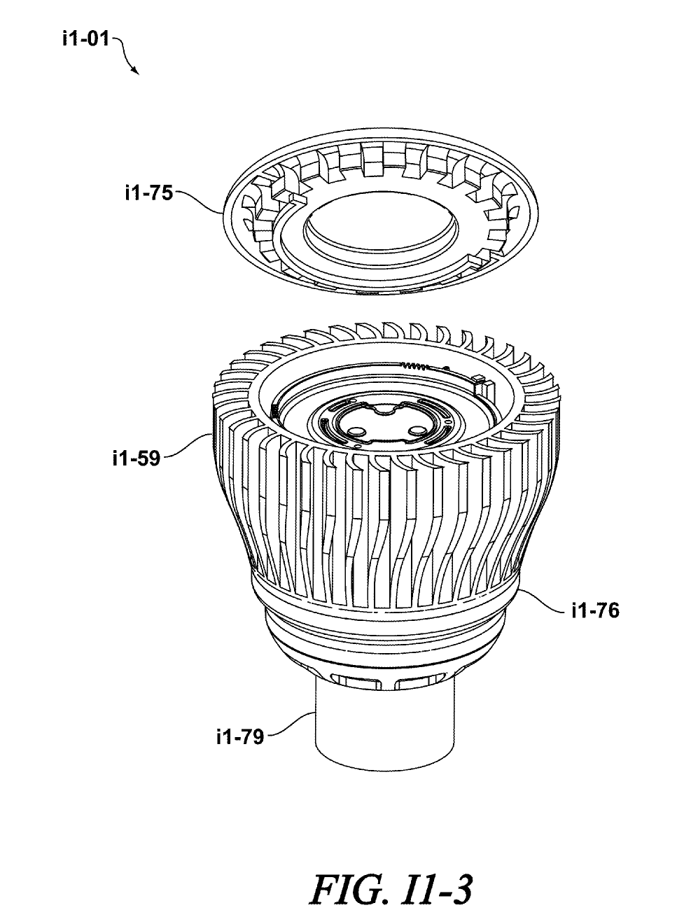

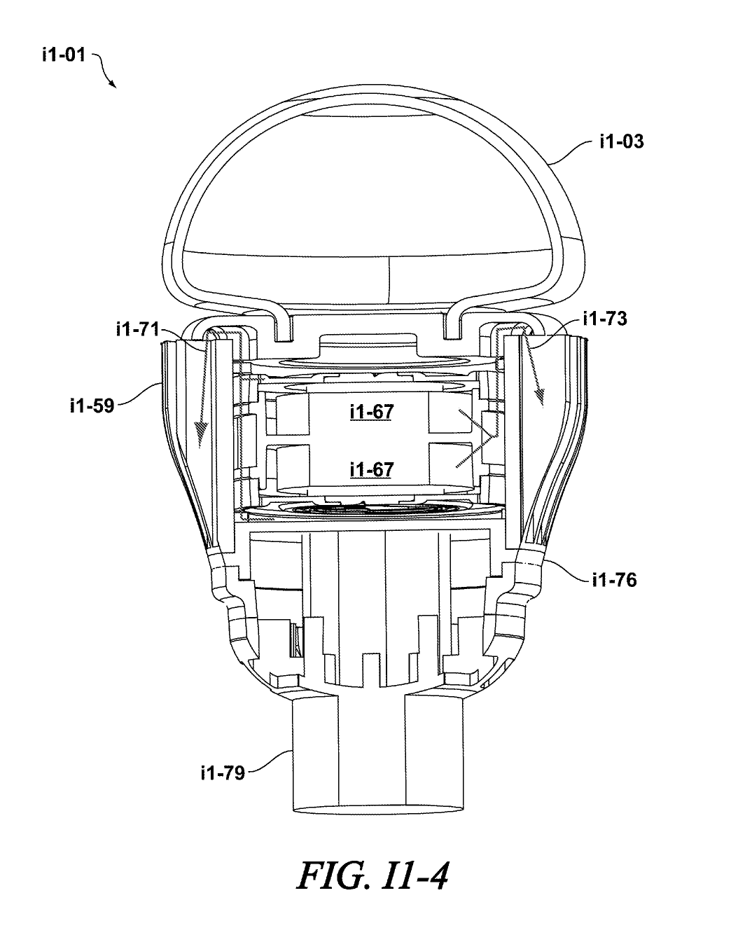

As best seen in FIG. 11-4, the synthetic jet ejector i1-09 comprises first and second voice coils i1-67 which drive first and second diaphragms i1-69. The synthetic jet ejector i1-09 has first i1-71 and second i1-73 channels defined therein which are in fluidic communication with a heat sink i1-59.

Notably, in the particular illumination device i1-01 depicted, elements of the host illumination device i1-01 define the housing of the synthetic jet ejector i1-09. Consequently, the overall space occupied by the synthetic jet ejector i1-09 is significantly reduced compared to the situation that would exist if the synthetic jet ejector was made as a standalone unit (with its own housing) and subsequently incorporated into the host device. Moreover, in this embodiment, the upper wall i1-75 (see FIG. I1-1) is thermally conductive and is in thermal communication with the heat sink fins i1-27, and hence forms part of the heat sink i1-59. This allows the synthetic jet ejector i1-09 to absorb a greater amount of heat, distribute it over a larger area, and disperse it to the external atmosphere with the fluidic flow used to create synthetic jets i1-17. As a further advantage, the synthetic jets i1-17 further help to dissipate heat to the external environment by disrupting the boundary layer at the surfaces of the fins i1-27 of the synthetic jet ejector i1-09.

### Heat Sinks

The various illumination devices described herein may be equipped with heat sources of various sizes, shapes and geometries. These heat sinks may be readily adapted to the space available within the illumination device or external to it. In some embodiments, these heat sinks may comprise a plurality of heat fins.

In some applications, it may be desirable to mount the heat sink on the exterior of a illumination device. Examples of such embodiments may be found in FIGS. C1-1, C2-1 and C3-1. As illustrated in the embodiment of FIGS. C4-1 and C4-2, however, the surface created by the heat fins may be covered by a smooth surface equipped with a plurality of apertures. Such a surface permits a fluidic flow between

The above description of the present invention is illustrative, and is not intended to be limiting. It will thus be appreciated that various additions, substitutions and modifications may be made to the above described embodiments without departing from the scope of the present invention. Accordingly, the scope of the present invention should be construed in reference to the appended claims.

### Appendix A

### Parts List

01: Illumination device
03: Light Emitting Portion
05: Electrical Connector Module
07: Synthetic Jet Actuator
09: Synthetic Jet Ejector
11: Actuator Housing
13: Diaphragm
15: LED
17: Synthetic Jet
19: Internal Aperture
20: Aperture in Actuator Housing
21: External Aperture
23: External Vent
25: Pedestal
27: Heat Fin
29: Synthetic Jet Ejector/Heat Sink Combination
31: LED Support Structure
33: Active Diaphragm
35: Passive Diaphragm
37: Channel
39: Externally Mounted LED
41: Nozzle
43: Synthetic Jet Actuator Support Structure
45: Reflective Material
47: Porous Medium
49: Heat Pipe
51: Internal Chamber
53: Region
55: Internal Housing Element
57: External Housing Element
59: Heat Sink
63: Arrow
65: Heat Spreader
67: Voice Coils
69: Diaphragm
71: 1^{st} Channel
73: 2^{nd} Channel
75: Upper Wall
76: Lower Wall
77: Heat Sink Cover
79: Base

1. An illumination device, comprising:
a housing;
a pedestal disposed in said housing;
a synthetic jet ejector supported by said pedestal; and
at least one LED supported by said synthetic jet ejector.

2. (canceled)

3. The illumination device of claim 1, wherein said synthetic jet ejector has first and second opposing surfaces having first and second LEDs, respectively, disposed thereon.

4. The illumination device of claim 1, wherein said synthetic jet ejector has third and fourth opposing surfaces having third and fourth LEDs, respectively, disposed thereon.

5. The illumination device of claim 1, wherein said synthetic jet ejector is essentially polyhedral in shape, wherein said synthetic jet ejector is attached to said pedestal across a first face of said polyhedron, and wherein at least one LED is disposed on each of the remaining faces of said polyhedron.

6-9. (canceled)

10. The illumination device of claim 1, wherein said LED is supported on a surface of said synthetic jet ejector, and wherein said synthetic jet ejector is adapted to emit a plurality of synthetic jets across said surface and adjacent to said LED.

11. (canceled)

12. The illumination device of claim 1, wherein said synthetic jet ejector has first and second diaphragms, wherein said housing has a longitudinal axis, and wherein said first and second diaphragms are oriented parallel to said longitudinal axis.

13. The illumination device of claim 1, further comprising:
a threaded connector module adapted to rotatingly engage said illumination device to a source of electricity.

14. (canceled)

15. The illumination device of claim 1, wherein said housing has at least one aperture therein such that the interior of said housing is in fluidic communication with the exterior of said housing.

16. The illumination device of claim 1, wherein said synthetic jet ejector has a plurality of fins disposed on an external surface thereof.

17. The illumination device of claim 16, wherein said synthetic jet ejector is adapted to emit a synthetic jet into a channel formed by opposing fins of said plurality of fins.

18. An illumination device, comprising:
a housing;
a threaded connector module adapted to rotatingly engage said illumination device to a source of electricity;
a synthetic jet actuator disposed in said connector module;
a manifold disposed on said housing and having a plurality of apertures therein;
an LED disposed on said manifold; and
a conduit in fluidic communication with said manifold and said synthetic jet actuator.

19-22. (canceled)

23. The illumination device of claim 18, wherein said LED is disposed adjacent to at least one of said plurality of apertures.

24. The illumination device of claim 1, wherein said pedestal comprises a heat pipe.

25. The illumination device of claim 18, further comprising a threaded connector module portion adapted to rotatingly engage said illumination device to a source of electricity, and wherein one end of said heat pipe terminates in said connector module portion.

26-31. (canceled)

32. An illumination device, comprising:
a heat spreader;
a housing, wherein said housing and said heat spreader form at least part of a hermetically sealed enclosure; and
an LED disposed on said heat spreader and within said enclosure.

33. The illumination device of claim 32, further comprising a synthetic jet ejector, wherein said synthetic jet ejector is external to said enclosure.

34. (canceled)

35. The illumination device of claim 34, further comprising a heat sink, and wherein said synthetic jet ejector is in fluidic communication with said heat sink.

36. The illumination device of claim 32, further comprising:
a threaded connector module adapted to rotatingly engage said illumination device to a source of electricity.

37. An illumination device, comprising:
a housing equipped with an aperture;
first and second diaphragms disposed in said housing and in fluidic communication with said aperture; and
an LED disposed within said housing and between said first and second diaphragms.

38. The illumination device of claim 37, wherein said first and second diaphragms are associated with first and second synthetic jet actuators.

39-40. (canceled)

41. The illumination device of claim 37, wherein said LED is disposed adjacent to said aperture.

42-46. (canceled)

47. An illumination device, comprising:
a housing;
an active diaphragm disposed in said housing;
a passive diaphragm disposed in said housing, said passive diaphragm being in fluidic communication with said active diaphragm; and
an LED disposed in said housing.

48. The illumination device of claim 47, wherein said LED is disposed between the active diaphragm and the passive diaphragm.

49. The illumination device of claim 48, wherein at least one of said active and passive diaphragms has a reflective surface.

50. (canceled)

51. The illumination device of claim 48, wherein at least one of said active and passive diaphragms has a surface which is reflective to the radiation emitted by said LED.

52. The illumination device of claim 51, wherein said reflective surface is specularly reflective.

53. The illumination device of claim 51, wherein said reflective surface is diffusely reflective.

54. An illumination device, comprising:
a base;
a helical portion in open communication with said base, said helical portion comprising an optically transmissive material;
a synthetic jet actuator disposed in said base; and
an LED disposed in said base, said LED being in optical communication with said helical portion.

55-71. (canceled)
